(19) United States
(12) Patent Application Publication
(10) Pub. No.: US 2013/0331592 A1
(43) Pub. Date: Dec. 12, 2013

(54) NOVEL POLYSILOXANES HAVING BETAINE GROUPS, PRODUCTION AND USE THEREOF

(71) Applicants: Christian Hartung, Essen (DE); Sascha Herrwerth, Essen (DE); Michael Ferenz, Essen (DE); Patrick Winter, Muelheim an der Ruhr (DE); Nicole Flintrop, Essen (DE)

(72) Inventors: Christian Hartung, Essen (DE); Sascha Herrwerth, Essen (DE); Michael Ferenz, Essen (DE); Patrick Winter, Muelheim an der Ruhr (DE); Nicole Flintrop, Essen (DE)

(73) Assignee: EVONIK GOLDSCHMIDT GMBH, Essen (DE)

(21) Appl. No.: 14/001,382

(22) PCT Filed: Feb. 1, 2012
(86) PCT No.: PCT/EP12/51624

§ 371 Date: Aug. 23, 2013

(30) Foreign Application Priority Data
Feb. 23, 2011 (DE) 10 2011 004 554.6
Aug. 17, 2011 (DE) 10 2011 110 921.1

(51) Int. Cl. C08G 77/14

(52) U.S. Cl. CPC C08G 77/14
USPC 556/418

(57) ABSTRACT

The invention relates to new types of polysiloxanes which contain at least one betaine group, and to a process for the preparation thereof. It also relates to the use of these polymers as care active ingredient in formulations, in particular for the care and cleaning of skin and skin appendages, such as, for example, as conditioning agent for hair. In addition, the invention relates to the formulations comprising these new types of compounds.

### FIELD OF THE INVENTION

The invention relates to new types of polysiloxanes which contain at least one betaine group, and to a process for their preparation. It also relates to the use of these polymers as care active ingredient in formulations, in particular for the care and cleaning of skin and skin appendages, such as, for example, as conditioning agents for hair, and to the use as, for example, textile softeners. In addition, the invention relates to the formulations comprising these new types of compounds.

### PRIOR ART

Human hair is exposed daily to a very wide variety of influences. As well as mechanical stresses due to brushing, combing, putting up or tying back, the hair is also attacked by environmental influences such as, for example, strong UV radiation, cold, heat, wind and water. The physiological state (e.g. age, health) of the particular person also influences the condition of the keratin fibres.

In particular, the treatment with chemical agents changes the structure and surface properties of the hair. Methods such as, for example, permanent waving, bleaching, colouring, tinting and straightening, but also frequent washing with aggressive surfactants contribute to greater or lesser damage being caused to the hair structure. Thus, for example, during a permanent wave, both the cortex and also the cuticle of the hair are attacked. The disulphide bridges of the cystine are broken by the reduction step and in the subsequent oxidation step are in part oxidized to cysteic acid.

The need for versatile active ingredients for cleaning and simultaneous care formulations for hair such as e.g. shampoos, leave-in conditioners, hair rinses and hair after-treatment compositions is therefore very great.

Very similar considerations to those for the treatment of hair likewise apply to the care and the finishing of textiles. Here too, compositions for the protection and for the care of the fibres are required.

Organomodified siloxanes are used in a wide variety of applications. A large number of different siloxane derivatives is also used in cosmetic and cleaning formulations for the care and cleaning of skin and hair. The properties of organomodified siloxanes can be adjusted in a targeted manner inter alia through the type of modification, and also by the density of modification.

Using allyl polyethers, it is possible to bond organophilic or non-ionic hydrophilic groups to a siloxane backbone. As care active ingredient for hair and skin, in the article “Les Copolymeres Polysiloxanes polyethers comme additifs dans les formulations cosmetiques” (Dr. Kollmeier; Parfums, Cosmetiques, Aromes; 51; 1983; 67-72) for example siloxanes are described which carry polyether groups in the middle and/or terminal position. WO 2002053111 describes the use of silicone polyether block copolymers with (AB)n structures in aqueous, surface-active body cleaning compositions which have good cosmetic properties especially for the volume, the combability and the shine of hair.

Commercial products based on polyethersiloxane, such as e.g. PEG-12 Dimethicone (according to INCI nomenclature; e.g. DC 5324 from Dow Corning), are also used for hair care. These polyethersiloxanes generally have good conditioning properties in hair care formulations, but are associated with a very great viscosity reduction in the formulations.

U.S. Pat. No. 5,879,671 describes the use of aqueous, surface-active body cleaning compositions which comprise mixtures of amino-functional siloxanes and polyethersiloxanes according to the prior art as care active ingredient. These mixtures bring about a permanent improvement in the dry and wet combability of the hair. Amino-functional siloxanes, such as e.g. the products obtainable under the INCI names Amodimethicone (e.g. SF 1708 from Momentive) or Aminopropyl Dimethicone (e.g. KF-8015 from Shin-Etsu), exhibit very good conditioning properties on skin and hair and, on account of the protonated and thus cationic amine functions present in the acidic pH range, i.e. ammonium compounds, good substantivity. However, these amino-functional siloxanes likewise have greatly viscosity-reducing properties in the formulations.

Polysiloxanes with quaternary ammonium groups, so-called quat groups, and the use thereof as additives for hair care and also as textile softeners are likewise known from the patent literature. Thus, for example, DE 1493384, EP 0017122 and U.S. Pat. No. 4,895,964 describe structures in which siloxanes are modified in the medium-position with quaternary ammonium groups distributed randomly over the polymer. These compounds have the disadvantage that they do not have a marked silicone character and only an averagely good effectiveness as conditioning agents for e.g. hair or textiles is observed.

A more pronounced silicone character is exhibited by cationic polysiloxanes, as described in DE 3719086 and EP 294642. These specifications describe structures in which the quaternary ammonium functions are bonded to the polysiloxane in the terminal position. Compounds of this type offer advantages with regard to their effect as conditioning agents both for hair and textiles and also for hard surfaces. The use of such compounds in cosmetic formulations has been described e.g. in EP 530974, EP 617607, EP 1080714, WO 201082879 and U.S. Pat. No. 6,207,141. These structures are commercially available e.g. under the INCI name Quaternium-80 (e.g. ABIL® Quat 3272 from Evonik Goldschmidt GmbH). However, these structures have only two quat groups. On account of the relatively low substantivity, the affinity of the polysiloxanes to certain surfaces is thus only moderate. Moreover, these α,ω-modified structures, like the corresponding polyether- or amino-modified siloxanes, have the disadvantage that they greatly lower the viscosity in typical surfactant formulations on account of the high silicone character.

EP 1887024 describes terminally cationic polysiloxanes with a T-siloxane structure and the use thereof as conditioning agents in cosmetic formulations. These cationic polysiloxanes exhibit a pronounced conditioning and shine-generating effect. This product is commercially available under the INCI name Silicone Quaternium-22 (ABIL® T Quat 60 from Evonik Goldschmidt GmbH). However, these silicone quats too have viscosity-lowering properties in surfactant formulations.

EP 164668 and EP 166122 claim siloxanes containing betaine groups and the use thereof in cosmetic preparations, primarily in hair care compositions. A commercial product is available for example under the INCI name Dimethicone Propyl PG-Betaine (e.g. ABIL® B 9950 from Evonik Goldschmidt GmbH). However, the following disadvantages are established also in the case of these structures:
1.) α,ω-modified silicone betaines have a relatively low substantivity and/or conditioning effect, and also relatively highly diluting effects in formulations, and
2.) products modified in the comb position likewise have an only moderate conditioning effect.

There is therefore thus also a need for versatile active ingredients with a very high conditioning effect and substantivity in cleaning and care formulations. Moreover, in this connection, it is extremely desirable that the viscosity of in particular surface-active formulations is not influenced or is barely influenced by the active ingredient, meaning that the addition of thickeners can be minimized.

It was an object of the invention to provide an active ingredient which is able to bring about very good conditioning and has an only slight effect on the viscosity of a wide variety of formulations.

### DESCRIPTION OF THE INVENTION

Surprisingly, it has been found that the silicone betaines described below and also processes for their preparation are able to solve the problem addressed by the invention. This is particularly surprising to the person skilled in the art since the structures according to the invention have a long, unsubstituted silicone middle block, and the silicone betaines according to the invention in formulations exhibit, contrary to expectations, a scarcely viscosity-altering effect.

The present invention therefore provides a process for the preparation of polysiloxanes containing at least one betaine group as described in claim 1, the betaine-group-containing siloxanes themselves obtainable thereby, and their use and formulations comprising the inventive betaine-group-containing siloxanes.

A particular advantage of betaine polysiloxanes according to the invention is their non-viscosity-reducing properties in surface-active formulations containing ether sulphate and betaine which are used to a substantial extent in the cosmetics industry. This leads to a significant reduction in thickeners required to adjust the formulations to the desired viscosity. This allows a simplification of the formulation, which takes into account the resource-conserving aspect.

One advantage of the betaine polysiloxanes according to the invention is their generally good compatibility with anionic components, in particular with anionic surfactants.

One advantage of the betaine polysiloxanes according to the invention is their high substantivity.

A further advantage of the polysiloxanes with betaine groups according to the invention is that they exert excellent conditioning effects on skin, hair and textiles.

A further advantage of the compounds according to the invention is that they improve the properties such as combability, softness, volume, shapeability, shine, manageability and the detangleability of undamaged and damaged hair.

A further advantage of the products according to the invention is that these polysiloxanes contribute to improved foaming behaviour, increased foam volume and/or better foam creaminess of the formulations.

The polysiloxanes according to the invention are described below by way of example without any intention of limiting the invention to these exemplary embodiments. Where ranges, general formulae or compound classes are stated below, then these are intended to include not only the corresponding ranges or groups of compounds that are explicitly mentioned, but also all part ranges and part groups of compounds which can be obtained by removing individual values (ranges) or compounds. Where documents are cited in the course of the present description, then their content, in its entirety, is deemed to form part of the disclosure of the present invention. Where in the course of the present invention compounds such as e.g. organomodified polysiloxanes or polyethers are described which can have a plurality of different units, these may occur in random distribution (random oligomer) or in an arranged manner (block oligomer) in these compounds. Details relating to the number of units in such compounds are to be understood as meaning the average value, averaged over all of the corresponding compounds.

Unless stated otherwise, all stated per cent (%) are per cent by mass.

All conditions such as, for example, pressure and temperature are standard conditions, unless stated otherwise.

The present invention provides a process for the preparation of polysiloxanes containing at least one betaine group, involving the process steps:
A) addition of organopolysiloxanes of the general formula I

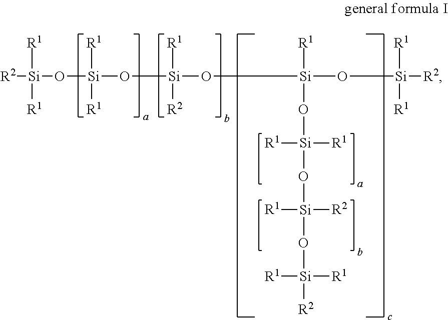

in which
R¹ independently of the others, is identical or different, branched or unbranched, aliphatic or aromatic hydrocarbon radicals having 1 to 20 carbon atoms, preferably unbranched, aliphatic or aromatic hydrocarbon radicals having 1 to 9 carbon atoms and particularly preferably methyl, ethyl or phenyl,
R² independently of the others, is identical or different radicals R¹ or H, with the proviso that at least three radicals R² are H,
a is 5 to 500, preferably 10 to 250, in particular 15 to 75,
b is 1 to 50, preferably 1 to 20, in particular 3 to 15,
c is 0 to 10, preferably 0 to 5, in particular 0,
onto vinylsiloxanes of the general formula II,

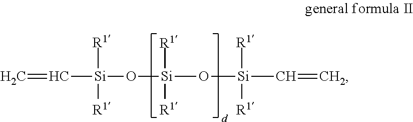

where
R^{1′} independently of the others, is identical or different, branched or unbranched, aliphatic or aromatic hydrocarbon radicals having 1 to 20 carbon atoms, preferably unbranched, aliphatic or aromatic hydrocarbon radicals having 1 to 9 carbon atoms and particularly preferably methyl, ethyl or phenyl,
d is 10 to 1000, preferably 101 to 750, in particular 201 to 500,
in the presence of platinum or rhodium catalysts,
with the proviso that the organopolysiloxanes of the general formula I are present in an at least 6-fold and at most 40-fold molar excess, based on the vinylsiloxane of the general formula II,
   to give a reaction product having SiH groups, and further reaction of the reaction product by process step B);
B) transition-metal-catalysed, partial or complete addition of the SiH groups of the products from process step A) onto at least one compound having at least one epoxy group selected from alkenyl and alkynyl compounds, in particular alkenyl compounds, selected from the group consisting of

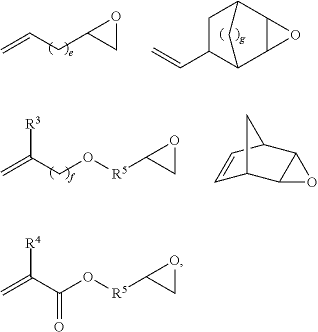

where
R³ is hydrogen or alkyl having 1 to 6 carbon atoms, preferably hydrogen,
R⁴ is hydrogen or alkyl having 1 to 6 carbon atoms, preferably methyl,
R⁵ independently of the others, is identical or different divalent hydrocarbon radicals which optionally contain ether functions, preferably methylene,
e is 0 to 30, preferably 0 to 12, in particular 0 to 6,
f is 0 to 18, preferably 0 to 6, in particular 1,
g is 0 to 2, preferably 0 to 1, in particular 0,
in particular an addition onto allyl glycidyl ether;
C) optionally additional, transition-metal-catalysed, partial or complete addition of the remaining SiH groups of the products from process step A) onto at least one compound selected from alkenyl and alkynyl compounds, such as, for example, α-olefins or polyethers containing double bonds, in particular selected from the group consisting of 1-dodecene, 1-hexadecene, 1-octadecene and allyl polyethers of the general formula III

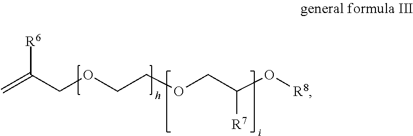

where
R⁶ is hydrogen or alkyl having 1 to 6 carbon atoms, preferably hydrogen or methyl, in particular hydrogen,
R⁷ independently of the others, is identical or different alkyl, aryl or alkaryl radicals having 1 to 30 carbon atoms which optionally contain ether functions, preferably methyl, ethyl or phenyl, in particular methyl,
R⁸ is alkyl radical having 1 to 18 carbon atoms, an acetate radical or hydrogen, preferably alkyl radical having 1 to 18 carbon atoms, an acetate radical and in particular methyl,
h is 0 to 100, preferably 1 to 50, in particular 1 to 30,
i is 0 to 100, preferably 1 to 50, in particular 1 to 30;
D) partial or complete reaction of the epoxy siloxanes obtained after process steps A), B) and optionally C) in process step d1) and/or d2):
   d1) with at least one amino acid derivative of the general formula IV

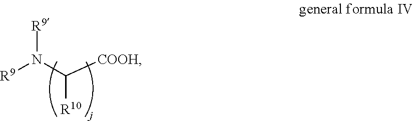

where
R⁹ is alkyl radical having 1 to 6 carbon atoms, preferably methyl,
R^{9′} is alkyl radical having 1 to 6 carbon atoms, preferably methyl,
R¹⁰ independently of the others, is identical or different, branched or unbranched, aliphatic or aromatic hydrocarbon radicals having 1 to 20 carbon atoms, which optionally contain ether, thiol, thiolether or hydroxyl functions, or hydrogen, preferably hydrogen,
j is 1 to 10, preferably 1 to 3, in particular 1,
to give betaine-group-modified siloxanes;
d2) with at least one secondary or tertiary amino compound selected from the group of the general formulae V, VI and VII,

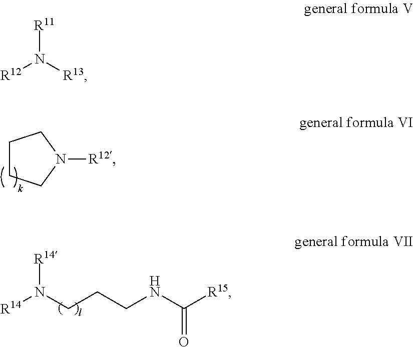

where
R¹¹ is alkyl radicals having 1 to 6 carbon atoms, preferably methyl,
R¹² is hydrogen or alkyl having 1 to 6 carbon atoms, preferably hydrogen or methyl,
R¹³ is alkyl, aryl or alkaryl radical having 1 to 30 carbon atoms which optionally contains ether functions,
R^{12′} is hydrogen or alkyl having 1 to 6 carbon atoms, preferably hydrogen or methyl,
k is 0 to 4, preferably 1 to 2, in particular 1,
R¹⁴ is ethyl or methyl, preferably methyl,
R^{14′} is ethyl or methyl, preferably methyl,
R¹⁵ is optionally branched, saturated or unsaturated alkyl radical having 1 to 30 carbon atoms which optionally contains ether or hydroxyl functions, preferably linear saturated alkyl radical having 8 to 22 carbon atoms,
l is 0 to 4, preferably 1,
with the proviso that in the case of formula VII or in the case of tertiary amines of the general formula V or VI (i.e. R¹² or R^{12′}≠H) an acid H⁺X⁻ is added in equimolar amounts with respect to this tertiary amine,
   where
   X⁻ is identical or different counterions to the positive charges on the quaternary ammonium groups formed, selected from inorganic or organic anions of the acids HX, preferably acetate, lactate, ethyl sulphate, methyl sulphate, toluenesulphonate, bromide or chloride,
to give tertiary amino- or quaternary ammonium-group-modified siloxanes, and;
E) optionally, in the case of the use of secondary amines in process step d2), i.e. R¹² or R^{12′}═H,
reaction of the resulting tertiary amino groups with

[Y(CH₂)ₘCOO]_{1/n}Z general formula VIII,
where
Y⁻ is ethyl sulphate, methyl sulphate, toluenesulphonate, bromide or chloride,
Znⁿ⁺ is alkali metal or alkaline earth metal cations, preferably Na⁺ or K⁺ and
m is 1 to 6, preferably 1 or 2, in particular 1,
to give betaine groups.

The proviso that the SiH-group-carrying organopolysiloxane of the general formula I is present in at least 6-fold molar excess, based on the double-bond-containing siloxane of the general formula II, prevents the development of a network and the formation of highly viscous products. Consequently, no elastomers or gels are formed. As a rule, the organosiloxanes prepared by the process have viscosities up to 100 000 mPas. A certain fraction of the organosiloxane can be present in the product in the form of a comb-like modified siloxane.

As is evident from the wording chosen above, optional process steps can be left out. Only process steps A), B) and d1) or the combination A), B), d2) and E) are necessary for forming the betaine group modification. In order to obtain a product with statistically at least one betaine group, a molar ratio of amino acid derivative of the formula IV to siloxane of the formula I of at least 1:1 is used here. Alternatively, a molar ratio of secondary amine of the formulae V/VI to acid derivative of the formula VIII to siloxane of the formula I of at least 1:1:1 can also be maintained.

On account of the selected reaction conditions, the double-bond-containing siloxane and the SiH-functional siloxane in process step A) form for example a siloxane of the idealized “H structure” shown in formula IX (c=0, R¹═R^{1′}═Me, R²═Me or H):

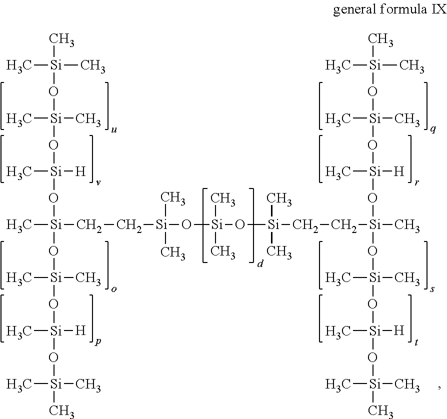

where

u+o=q+s=a and

v+p=r+t=b−1.

The person skilled in the art will appreciate that the general formula IX given above is an idealized structural formula. More highly branched/bridged structures may additionally be present in the product.

This siloxane backbone is retained during the subsequent process steps.

The synthesis of the siloxane polymers can take place with or without solvents. The foaming that may arise can be suppressed by using solvents. Suitable solvents are, for example, toluene, cyclohexane and isopropanol.

Effective catalysts which can be used for process steps A), B) and/or optionally C), i.e.

the hydrosilylation of siloxanes with SiH groups onto CC multiple bonds, may be precious metal catalysts such as Pt- and Rh-containing complexes which are known to the person skilled in the art as hydrosilylation-active catalysts, for example: H₂PtCl₆, (NH₃)₂PtCl₂, Pt[(CH₂═CH—SiMe₂)₂O]ₙ, or Rh(CO)(C₅H₇O₂). Suitable and preferred conditions for the hydrosilylation reaction are described in particular e.g. in EP 1520870; this is hereby incorporated by reference with regard to these conditions and forms part of the disclosure of the present invention.

Suitable alkenyl/alkynyl compounds in process step C) are, for example, polyethers with multiple bonds, for example allyl-functional polyethers, olefins, ethene, ethyne, propene, 1-butene, 1-hexene, 1-dodecene, 1-hexadecene, allyl alcohol, 1-hexenol, styrene, eugenol, allylphenol, undecylenic acid methyl ester. Of particular suitability are polyethers with double bonds, in particular allyl-functional polyethers.

Process steps A), B) and/or optionally C can be carried out sequentially or simultaneously.

The reaction of the epoxysiloxanes with amino acid derivatives of process step d1) to give betaine-group-modified siloxanes is described, for example, in EP 0166122; the reaction with amines to give tertiary amine- or quaternary ammonium-group-carrying siloxanes of process steps d2) and E) is explained, for example, in DE 37 19 086 and EP 0 294 642.

The polysiloxanes containing betaine groups and obtainable by the process according to the invention are likewise provided by the present invention.

The betaine polysiloxanes according to the invention contain at least one, preferably at least three, particularly preferably at least five, betaine groups.

Preferred betaine polysiloxanes according to the invention are obtained using the processes described above as being preferred.

This invention further provides the use of the betaine polysiloxanes according to the invention or betaine polysiloxanes obtainable by the process according to the invention for producing cosmetic, pharmaceutical or dermatological formulations.

According to the invention, it is possible to use water-soluble or water-insoluble polysiloxanes—also for the uses according to the invention specified below. Depending on the formulation to be produced (opaque or clear formulations), the person skilled in the art will know whether water-soluble or insoluble polysiloxanes should be used for producing the formulation. Within the context of the present invention, the term “water-insoluble” is defined as a solubility of less than 0.01% by weight in aqueous solution at 20° C. and 1 bar pressure. Within the context of the present invention, the term “water-soluble” is defined as a solubility of equal to or more than 0.01% by weight in aqueous solution at 20° C. and 1 bar pressure.

This invention further provides the use of the betaine polysiloxanes according to the invention or betaine polysiloxanes obtainable by the process according to the invention as care active ingredient in, preferably surfactant-containing aqueous, care and cleaning formulations.

Here, the term “care active ingredient” is understood as meaning a substance which satisfies the purpose of retaining an object in its original form, of reducing or avoiding the effects of external influences (e.g. time, light, temperature, pressure, soiling, chemical reaction with other reactive compounds which come into contact with the object), such as, for example, ageing, soiling, material fatigue, bleaching, or even of improving desired positive properties of the object. For the last point, mention may be made for example of improved hair shine or greater elasticity of the object under consideration.

A preferred care formulation in this connection is a shine-improving care formulation. In this connection, the care and cleaning formulations are not limited to cosmetic, pharmaceutical or dermatological formulations, but may also be those formulations which are used domestically and in industry, for example for the care and cleaning of surfaces of inanimate objects such as, for example, tiles, wood, glass, ceramics, linoleum, plastic, painted surfaces, leather, fabrics, fibres. Examples of such objects are window panes and window ledges, shower partitions, floorings such as carpets, tiles, laminates, parquet, cork floorings, marble, stone and fine stoneware floors, household ceramics such as WCs, wash basins, bidets, shower trays, bath tubs, door handles, fittings, domestic appliances such as washing machines, driers, dishwashers, sinks made of ceramic or stainless steel, furniture such as tables, chairs, shelves, storage areas, windows, cookware, crockery and cutlery, laundry, in particular laundry close to the body (“underwear”), water vessels, vehicles and aircraft such as cars, buses, motorized boats and sail boats, objects such as surgical instruments, vacuum cleaners, engines, pipelines, containers and equipment for transportation, processing and storage in food processing. Consequently, in this connection, it concerns use in cleaning and care compositions for domestic, industrial and institutional application. In this connection, the surface to be cared for and cleaned is preferably that of a fibre or a textile, in particular the surface of woven textiles, laundry, upholstery or carpets. This invention further provides the use of the betaine polysiloxanes according to the invention or betaine polysiloxanes obtainable by the process according to the invention as conditioning agents for hair treatment compositions and hair after-treatment compositions, and also as agents for improving hair structure.

The present invention further provides cosmetic, pharmaceutical or dermatological formulations, preferably cosmetic care and cleaning formulations, in particular surfactant-containing aqueous care and cleaning formulations, such as e.g. shampoos, liquid soaps and shower gels, comprising betaine polysiloxanes according to the invention or betaine polysiloxanes obtainable by the process according to the invention. Cosmetic care formulations preferred according to the invention are in particular hair-treatment compositions and hair after-treatment compositions for rinsing out or for leaving in the hair, for example shampoos with or without pronounced conditioning effect, 2in1 shampoos, rinses, hair treatments, hair masks, styling aids, styling compositions, blow-waving lotions, hair-setting compositions, permanent waving compositions, hair-smoothing compositions and compositions for colouring the hair comprising at least one of the polysiloxanes according to the invention or one of the polysiloxanes obtainable, preferably obtained, by the process according to the invention.

The betaine polysiloxanes according to the invention or the betaine polysiloxanes obtainable by the process according to the invention are advantageously used in the compositions according to the invention in a concentration of from 0.01 to 20 mass per cent, preferably 0.1 to 8 mass per cent, particularly preferably from 0.2 to 4 mass per cent.

The cosmetic formulations comprising the betaine polysiloxanes according to the invention or the betaine polysiloxanes obtainable by the process according to the invention can comprise e.g. at least one additional component selected from the group of emollients, emulsifiers and surfactants, thickeners/viscosity regulators/stabilizers, UV light protection filters, antioxidants and vitamins, hydrotropes (or polyols), solids and fillers, film formers, pearlescent additives, deodorant and antiperspirant active ingredients, insect repellents, self-tanning agents, preservatives, conditioners, perfumes, dyes, biogenic active ingredients, care additives, superfatting agents and solvents. Substances which can be used as exemplary representatives of the individual groups are known to the person skilled in the art and can be found for example in the German application DE 102008001788.4. This patent application is hereby incorporated by reference and thus forms part of the disclosure. As regards further optional components and the amounts of these components used, reference is made expressly to the relevant handbooks known to the person skilled in the art, e.g. K. Schrader, “Grundlagen and Rezepturen der Kosmetika [Fundamentals and Formulations of Cosmetics]”, 2^{nd} Edition, pages 329 to 341, Hüthig Buch Verlag Heidelberg.

The amounts of the particular additives depend on the intended use.

Typical guide formulations for the respective applications are known prior art and are present for example in the brochures of the manufacturers of the particular basic materials and active ingredients. These existing formulations can generally be adopted unchanged. If necessary, the desired modifications can, however, be undertaken by simple experiments without complication for the purposes of adaptation and optimization.

This invention further provides cleaning and care formulations for domestic, industrial and institutional applications such as, for example, disinfectants, disinfection cleaners, foam cleaners, floor cleaners, carpet cleaners, upholstery cleaners, floor care products, marble cleaners, parquet cleaners, stone and ceramic floor cleaners, wipe care compositions, stainless steel cleaners, glass cleaners, dishwashing detergents, plastic cleaners, sanitary cleaners, wood cleaners, leather cleaners, detergents, laundry care compositions, disinfectant detergents, heavy-duty detergents, mild detergents, wool detergents, fabric softeners, impregnating compositions comprising at least one of the polysiloxanes according to the invention or one of the polysiloxanes obtainable, preferably obtained, by the process according to the invention. Cleaning and care formulations for domestic, industrial and institutional applications preferred in this connection are detergents, laundry care compositions, heavy-duty detergents, mild detergents, wool detergents, fabric softeners, impregnating compositions, in particular fabric softeners.

The present invention is described by way of example in the examples listed below without any intention of limiting the invention, the scope of application of which arises from the entire description and the claims, to the embodiments specified in the examples.

### EXAMPLES

### Example 1

### Preparation of a Polysiloxane with Betaine Modification

In a four-neck flask fitted with stirrer, reflux condenser, thermometer and dropping funnel, 65.0 g (2.5 mmol) of an α,ω-divinylsiloxane of the general formula CH₂═CH—SiMe₂O—(SiMe₂O)₃₄₈—SiMe₂—CH═CH₂ and 74.2 g (650 mmol) of allyl glycidyl ether (AGE) were dissolved in 200 ml of toluene, heated to 100° C. and admixed with 4.3 mg of (NH₃)₂PtCl₂. 141.5 g (50.0 mmol or 500.0 mmol of SiH groups) of an SiH-functional siloxane of the general formula Me₃SiO—(SiMe₂O)₂₈(SiMeHO)₁₀SiMe₃ were added dropwise with stirring and the reaction mixture was reacted for 2 h at 100° C. to an SiH conversion of >95%. The reaction product was distilled for 2 h at 120° C. and a vacuum of 1 mbar in order to separate off toluene, excess AGE and other volatile secondary constituents.

The slightly opaque epoxy siloxane product was then dissolved in 300 ml of isopropanol, admixed with 51.6 g (500 mmol) of N,N-dimethylglycine and heated at 80° C. for 6 h. 315.2 g of propylene glycol were added and the isopropanol was distilled off in vacuo at 100 mbar and 80° C. A light yellow, slightly opaque product was obtained which comprises 50% propylene glycol and shows an epoxy conversion of >98% in the ¹H-NMR.

### Example 2

### Preparation of a Polysiloxane with Betaine Modification

In a four-neck flask fitted with stirrer, reflux condenser, thermometer and dropping funnel, 65.0 g (2.5 mmol) of a divinylsiloxane of the general formula CH₂═CH—SiMe₂O—(SiMe₂O)₃₄₈—SiMe₂—CH═CH₂ and 74.2 g (650 mmol) of allyl glycidyl ether (AGE) were dissolved in 250 ml of toluene, heated to 100° C. and admixed with 4.9 mg of (NH₃)₂PtCl₂. 178.6 g (50.0 mmol or 500.0 mmol of SiH) of an SiH-functional siloxane of the general formula Me₃SiO—(SiMe₂O)₃₈(SiMeHO)₁₀SiMe₃ were added dropwise with stirring and the reaction mixture was reacted for 3 h at 110° C. to an SiH conversion of >95%. The reaction product was distilled for 2 h at 120° C. and a vacuum of 1 mbar in order to separate off toluene, excess AGE and other volatile secondary constituents. The slightly opaque epoxy siloxane product was then dissolved in 300 ml of isopropanol, admixed with 51.6 g (500 mmol) of N,N-dimethylglycine and heated for 6 h at 80° C. 352.1 g of propylene glycol were added and the isopropanol was distilled off in vacuo at 100 mbar and 80° C. A pale yellow, slightly opaque product was obtained which comprises 50% propylene glycol and shows an epoxy conversion of >98% in the ¹H-NMR.

### Example 3

### Preparation of a Polysiloxane with Betaine and Polyether Modification

In a four-neck flask fitted with stirrer, reflux condenser, thermometer and dropping funnel, 141.5 g (50.0 mmol or 500.0 mmol of SiH) of an SiH-functional siloxane of the general formula Me₃SiO—(SiMe₂O)₂₈(SiMeHO)₁₀SiMe₃ were introduced as initial charge, heated to 120° C. and admixed with 11.6 mg of (cyclohexene)₂Pt₂Cl₄ and 0.32 g N-ethyl-N,N-diisopropylamine. 34.2 g (300 mmol) of allyl glycidyl ether (AGE) were added dropwise with stirring and left being stirred for 1 h at 120° C. Then, 65.0 g (2.5 mmol) of a divinylsiloxane of the general formula CH₂═CH—SiMe₂O—(SiMe₂O)₃₄₈—SiMe₂—CH═CH₂ were added and the mixture was reacted for a further hour at 120° C. before 398.7 g (350 mmol) of an allyl polyether of the general formula H₂C=CH—CH₂—(OCH₂CH₂)₁₅—(OCH₂CH(CH₃))₇—OCH₃ were added dropwise. Following the addition of a further 3.5 mg of (cyclohexene)₂Pt₂Cl₄, after 3 h at 120° C., an SiH conversion of >95% was achieved. The reaction product mixture was distilled for 2 h at 120° C. and a vacuum of 1 mbar in order to separate off excess AGE and other volatile secondary constituents. The milky-opaque epoxy-polyether-siloxane product was then dissolved in 700 ml of isopropanol, admixed with 30.9 g (300 mmol) of N,N-dimethylglycine and heated for 6 h at 80° C. 670.0 g of propylene glycol were added and the isopropanol was distilled off in vacuo at 100 mbar and 80° C. A pale yellow, opaque product was obtained which comprises 50% propylene glycol.

### Example 4

### Preparation of a Polysiloxane with Betaine and C12-alkyl Modification

In a four-neck flask fitted with stirrer, reflux condenser, thermometer and dropping funnel, 61.3 g (3.3 mmol) of a divinylsiloxane of the general formula CH₂═CH—SiMe₂O—(SiMe₂O)₂₄₈—SiMe₂—CH═CH₂, 33.7 g (200 mmol) of 1-dodecene and 51.4 g (450 mmol) of allyl glycidyl ether (AGE) were dissolved in 300 ml of toluene, heated to 100° C. and admixed with 4.4 mg of (NH₃)₂PtCl₂. 141.5 g (50.0 mmol or 500.0 mmol of SiH) of an SiH-functional siloxane of the general formula Me₃SiO—(SiMe₂O)₂₈(SiMeHO)₁₀SiMe₃ were added dropwise with stirring and the reaction mixture was reacted for 4 h at 100° C. to an SiH conversion of >95%. The reaction product mixture was distilled for 2 h at 120° C. and a vacuum of 1 mbar in order to separate off toluene, excess AGE and dodecene and also other volatile secondary constituents.

The slightly opaque epoxy-alkyl-siloxane product was then dissolved in 300 ml of isopropanol, admixed with 36.1 g (350 mmol) of N,N-dimethylglycine and heated for 6 h at 80° C. The isopropanol was distilled off in vacuo at 100 mbar and 80° C. A viscous, pale yellow, slightly opaque product was obtained. It shows an epoxy conversion of >98% in the ¹H-NMR.

### Comparative Example 5

Betaine-group-containing siloxane ABIL® B 9950 (commercially available from Evonik Goldschmidt GmbH, INCI: Dimethicone Propyl PG-Betaine; active content: 30%)

### Comparative Example 6

Polyether-group-containing siloxane DC 5324 (commercially available from Dow Corning, INCI: PEG-12 Dimethicone)

### Comparative Example 7

Quat-group-containing Siloxane ABIL® Quat 3272 (commercially available from Evonik Goldschmidt GmbH, INCI: Quaternium-80; active content 50%)

### Comparative Example 8

Amino-group-containing siloxane DC 2-8566 (commercially available from Dow Corning, INCI: Amodimethicone)

### Example 9

### Preparation of a Polysiloxane with Betaine Modification

In a four-neck flask fitted with stirrer, reflux condenser, thermometer and dropping funnel, 70.0 g (14.9 mmol or 149.0 mmol of SiH) of an SiH-functional siloxane of the general formula HMe₂SiO—(SiMe₂O)₅₅(SiMeHO)₈SiMe₂H in 100 ml of toluene were introduced as initial charge, heated to 110° C. and admixed with 22.0 mg of (cyclohexene)₂Pt₂Cl₄ and 0.06 g of N-ethyl-N,N-diisopropylamine. 8.4 g (73.6 mmol) of allyl glycidyl ether (AGE) were added dropwise with stirring and left being stirred for 1 h at 110° C. Then, 20.4 g (0.8 mmol) of a divinylsiloxane of the general formula CH₂═CH—SiMe₂O—(SiMe₂O)₃₄₈—SiMe₂—CH═CH₂ were added and the mixture was reacted for a further hour at 110° C. before 11.0 g (96.4 mmol) of allyl glycidyl ether were added dropwise. After 3 h at 110° C., an SiH conversion of >95% was achieved. The reaction product mixture was distilled for 2 h at 120° C. and a vacuum of 1 mbar in order to separate off toluene, excess AGE and other volatile secondary constituents. The opaque epoxysiloxane product was then dissolved in 150 ml of isopropanol, admixed with 15.2 g (149.0 mmol) of N,N-dimethylglycine and heated for 6 h at 80° C. 122.5 g of propylene glycol were added and the isopropanol was distilled off in vacuo at 100 mbar and 80° C. A pale yellow, opaque product was obtained which comprises 50% propylene glycol and shows an epoxy conversion of >97% in the ¹H-NMR.

### Example 10

### Preparation of a Polysiloxane with Betaine Modification

In a four-neck flask fitted with stirrer, reflux condenser, thermometer and dropping funnel, 54.1 g (2.9 mmol) of an α,ω-divinylsiloxane of the general formula CH₂═CH—SiMe₂O—(SiMe₂O)₂₄₈—SiMe₂—CH═CH₂ and 78.0 g (683.4 mmol) of allyl glycidyl ether (AGE) were dissolved in 300 ml of toluene, heated to 100° C. and admixed with 5.7 mg of (NH₃)₂PtCl₂. 166.9 g (58.3 mmol or 583.2 mmol of SiH groups) of an SiH-functional siloxane of the general formula Me₃SiO—(SiMe₂O)₂₈(SiMeHO)₁₀SiMe₃ were added dropwise with stirring. The reaction mixture is converted after 2 h at 110° C. to an SiH conversion of >95%. The reaction product was distilled for 2 h at 120° C. and a vacuum of 1 mbar in order to separate off toluene, excess AGE and other volatile secondary constituents.

The slightly opaque epoxysiloxane product was then dissolved in 300 ml of isopropanol, admixed with 60.1 g (583.2 mmol) of N,N-dimethylglycine and heated for 6 h at 80° C. 347 g of dipropylene glycol were added and the isopropanol was distilled off in vacuo at 100 mbar and 80° C. A pale yellow, slightly opaque product was obtained which comprises 50% dipropylene glycol and shows an epoxy conversion of >98% in the ¹H-NMR.

### Example 11

### Preparation of a Polysiloxane with Betaine and Quat Modification

In a four-neck flask fitted with stirrer, reflux condenser, thermometer and dropping funnel, 65.0 g (2.5 mmol) of an α,ω-divinylsiloxane of the general formula CH₂═CH—SiMe₂O—(SiMe₂O)₃₄₈—SiMe₂—CH═CH₂ and 74.2 g (650 mmol) of allyl glycidyl ether (AGE) were dissolved in 250 ml of toluene, heated to 100° C. and admixed with 4.3 mg of (NH₃)₂PtCl₂. 141.5 g (50.0 mmol or 500.0 mmol of SiH groups) of an SiH-functional siloxane of the general formula Me₃SiO—(SiMe₂O)₂₈(SiMeH0)₁₀SiMe₃ were added dropwise with stirring and the reaction mixture was reacted for 2 h at 100° C. to an SiH conversion of >95%. The reaction product was distilled for 2 h at 120° C. and a vacuum of 1 mbar in order to separate off toluene, excess AGE and other volatile secondary constituents.

The opaque epoxysiloxane product was then dissolved in 250 ml of isopropanol, admixed with 45.7 g (400.0 mmol) of N,N-dimethylglycine and 13.3 g (100.0 mmol) of N,N-dimethylaminoethoxyethanol and 6.2 g (103.0 mmol) of acetic acid and heated for 6 h at 80° C. 329 g of propylene glycol were added and the isopropanol was distilled off in vacuo at 100 mbar and 80° C. A pale yellow, opaque product was obtained which comprises 50% propylene glycol and shows an epoxy conversion of >97% in the 1H-NMR.

### Application Examples

### Application Properties

The formulation constituents are named in the compositions in the form of the generally recognized INCI nomenclature.

All concentrations in the application examples are given in per cent by weight.
1.) Testing the Conditioning of Hair by Means of Sensory Tests:

For the application-related assessment of the conditioning of hair, Examples 1 and 2 according to the invention and comparative Examples 5, 6 and 8 were used in simple shampoo formulations.

The application properties upon use in a shampoo were tested in the following formulations:

TABLE 1
Shampoo formulations for testing the hair-conditioning properties.

| | Formulation Examples | | | | | |
|---|---|---|---|---|---|---|
| | 0a | 1a | 2a | C3a | C4a | C5a |
| Texapon NSO ®, 28% strength, | 32.0% | 32.0% | 32.0% | 32.0% | 32.0% | 32.0% |
| Cognis | | | | | | |
| (INCI: Sodium Laureth Sulfate) | | | | | | |
| TEGO ® Betain F 50, 38% strength, | 8.0% | 8.0% | 8.0% | 8.0% | 8.0% | 8.0% |
| Evonik Goldschmidt GmbH | | | | | | |
| (INCI: Cocamidopropyl Betaine) | | | | | | |
| Jaguar 162, Rhodia | 0.2% | 0.2% | 0.2% | 0.2% | 0.2% | 0.2% |
| (INCI: Guar Hydroxypropyl | | | | | | |
| trimonium Chloride) | | | | | | |
| (Cationic polymer to improve the | | | | | | |
| effectiveness of conditioning | | | | | | |
| agents) | | | | | | |
| Water, demineralized | ad 100.0% | | | | | |
| Citric acid | ad pH 6.0 ± 0.3 | | | | | |
| Example 1 | | 1.0% | | | | |
| (according to the invention, 50% | | | | | | |
| silicone active content) | | | | | | |
| Example 2 | | | 1.0% | | | |
| (according to the invention, 50% | | | | | | |
| silicone active content) | | | | | | |
| Comparative Example 5 | | | | 1.67% | | |
| (not according to the invention, | | | | | | |
| 30% silicone active content) | | | | | | |
| Comparative Example 6 | | | | | 0.5% | |
| (not according to the invention) | | | | | | |
| Comparative Example 8 | | | | | | 0.5% |
| (not according to the invention) | | | | | | |

To assess the properties of the shampoo formulation, in the course of the test no after-treatment with a rinse was carried out.

For the application-related assessment, hair tresses which are used for sensory tests are predamaged in a standardized manner by a permanent waving treatment and a bleaching treatment. Products customary in hairdressing are used for this purpose. The test procedure, the base materials used and the details of the assessment criteria are described in DE 103 27 871.

Standardized treatment of predamaged hair tresses with conditioning samples:

The hair tresses, predamaged as described above, are treated as follows with the shampoo described above:

The hair tresses are wetted under running warm water. The excess water is gently squeezed out by hand, then the shampoo is applied and worked gently into the hair (1 ml/hair tress (2 g)). After a residence time of 1 min, the hair is rinsed for 1 min. Prior to the sensory assessment, the hair is dried in air at 50% atmospheric humidity and 25° C. for at least 12 h.

### Assessment Criteria:

The sensory evaluations take place by means of grades which are awarded on a scale from 1 to 5, with 1 being the worst evaluation and 5 being the best evaluation. The individual test criteria are each given their own evaluation.

The test criteria are: wet combability, wet feel, dry combability, dry feel, appearance/shine.

The table below compares the results of the sensory assessment of the treatment, carried out as described above, of the hair tresses with the formulations 1a and 2a according to the invention, the comparison formulations C3a, C4a and C5a and the control formulation 0a (placebo without test substance).

TABLE 2
Results of the conditioning of hair from shampoo formulation.

| | Wet | | Dry | | |
|---|---|---|---|---|---|
| | comb- | Wet | comb- | Dry | |
| | ability | feel | ability | feel | Shine |
| Formulation 1a according | 4.1 | 4.1 | 3.6 | 4.2 | 4.3 |
| to the invention | | | | | |
| Formulation 2a according | 4.2 | 4.0 | 3.8 | 4.0 | 4.4 |
| to the invention | | | | | |
| Comparison formulation | 3.0 | 3.1 | 3.2 | 3.4 | 3.3 |
| C3a (not according to | | | | | |
| the invention) | | | | | |
| Comparison formulation | 3.3 | 3.4 | 3.3 | 3.4 | 3.4 |
| C4a (not according to | | | | | |
| the invention) | | | | | |
| Comparison formulation | 3.7 | 3.6 | 3.3 | 3.5 | 3.5 |
| C5a (not according to | | | | | |
| the invention) | | | | | |
| Control formulation 0a | 2.1 | 2.3 | 2.5 | 3.1 | 2.3 |
| (placebo) | | | | | |

The results surprisingly show that the formulation la and 2a according to the invention with Examples 1 and 2 according to the invention are given significantly better evaluations than the comparison formulation C3a, C4a and C5a with the comparative Examples 5, 6 and 8 according to the prior art.
2.) Testing the Conditioning of Skin by Means of a Hand Washing Test:

To evaluate the conditioning of skin (skin care performance) of the Examples 1 and 2 according to the invention in aqueous, surface-active formulations, sensory hand-washing tests were carried out compared to the comparative Examples 5, 6 and 8 according to the prior art.

The comparative Examples 5, 6 and 8 are widespread in industry as care active ingredient and are deemed to be highly effective care active ingredients in aqueous, surface-active formulations.

A group consisting of 10 trained subjects washed their hands in a defined manner and evaluated foam properties and skin feel using a grading scale from 1 (poor) to 5 (very good).

The products used were tested in each case in a standardized surfactant formulation (Table 3). The control formulation 0b used is a formulation without the addition of an organomodified siloxane.

TABLE 3
Test formulations for hand washing test.

| | Formulation Examples | | | | | |
|---|---|---|---|---|---|---|
| | 0b | 1b | 2b | C3b | C4b | C5b |
| Texapon NSO ®, 28% strength, | 32.0% | 32.0% | 32.0% | 32.0% | 32.0% | 32.0% |
| Cognis | | | | | | |
| (INCI: Sodium Laureth Sulfate) | | | | | | |
| TEGO ® Betain F 50, 38% | 8.0% | 8.0% | 8.0% | 8.0% | 8.0% | 8.0% |
| strength, | | | | | | |
| Evonik Goldschmidt GmbH | | | | | | |
| (INCI: Cocamidopropyl Betaine) | | | | | | |
| NaCl | 2.0% | 2.0% | 2.0% | 2.0% | 2.0% | 2.0% |
| Water, demineralized | ad 100.0% | | | | | |
| Example 1 (according to the | | 1.0% | | | | |
| invention, 50% silicone active | | | | | | |
| content) | | | | | | |
| Example 2 (according to the | | | 1.0% | | | |
| invention, 50% silicone active | | | | | | |
| content) | | | | | | |
| Comparative Example 5 (not | | | | 1.67% | | |
| according to the invention, 30% | | | | | | |
| silicone active content) | | | | | | |
| Comparative Example 6 (not | | | | | 0.5% | |
| according to the invention) | | | | | | |
| Comparative Example 8 (not | | | | | | 0.5% |
| according to the invention) | | | | | | |

The sensory test results are summarized in Table 4.

TABLE 4
Results of the hand washing test.

| | Test formulation | | | | | |
|---|---|---|---|---|---|---|
| | 0b | 1b | 2b | C3b | C4b | C5b |
| Skin feel during washing | 2.6 | 4.1 | 4.0 | 3.5 | 3.4 | 3.6 |
| Skin smoothness | 1.4 | 3.9 | 4.1 | 3.4 | 3.5 | 3.4 |
| Skin softness | 2.0 | 3.6 | 3.8 | 3.3 | 3.4 | 3.4 |
| Skin smoothness after 3 min | 2.6 | 3.9 | 3.8 | 3.1 | 3.0 | 3.4 |
| Skin softness after 3 min | 2.5 | 3.8 | 4.0 | 3.1 | 3.4 | 3.3 |

Table 4 shows the results of the hand washing test. It is evident from the measurement results that the formulations 1b and 2b according to the invention using the Examples 1 and 2 according to the invention are superior in all application properties compared to the comparison formulations C3b, C4b and C5b according to the prior art. Against this background, the results of the formulations 1b and 2b according to the invention are to be described as very good.

It is evident from the measurement values that the Examples 1 and 2 according to the invention in the formulations 1b and 2b lead to an improvement in skin properties compared to the comparative Examples 5, 6 and 8. In addition, the measurement values reveal that the control formulation 0b without a silicone compound has poorer measurement values than the other test formulations.
3.) Viscosity Effect:

To examine the viscosity effects of the Examples 1 and 2 according to the invention and of comparative Examples 5, 6, 7 and 8 according to the prior art, these compounds were tested in two typical shampoo formulations with the two thickeners NaCl and the commercially available product ANTIL® 171 (Evonik Goldschmidt GmbH; INCI: PEG-18 Glyceryl Oleate/Cocoate). In a typical shampoo formulation, 0.2% Polyquaternium-10 (PQ-10) was used as base conditioner or deposition polymer (see 3a). In the other typical shampoo formulation, 0.2% guar quat (see 3b) was used as base conditioner or deposition polymer.

The formulations were stored following preparation for 24 hours at 25° C. and then the viscosity was measured using a Brookfield viscometer (Brookfield LVF, Spindel 3, 5 rpm) at 25° C.
3a) Viscosity Effects in the Case of Shampoo Formulations When Using Polyquaternium-10 (PQ-10):

The control formulation 0c used is a formulation without addition of a silicone compound (conditioner) using 0.2% PQ-10. In the case of the formulations 1c and 2c according to the invention and the comparison formulations C3c, C4c, C5c and C6c, 0.2% PQ-10 with in each case 0.5% silicone compound was used.

The results of formulations 1c and 2c with the Examples 1 and 2 according to the invention, of formulations C3c, C4c, C5c and C6c with the comparative Examples 5, 6, 7 and 8 according to the prior art and of the control formulation 0c without the addition of a silicone compound (test formulation) are summarized in Table 5.

TABLE 5
Measured viscosities when using NaCl and PEG-18 Glyceryl Oleate/Cocoate
(ANTIL 171, Evonik Goldschmidt GmbH) for thickening the aqueous, surface-active
formulation.

| | Formulation Examples | | | | | | |
|---|---|---|---|---|---|---|---|
| | 0c | 1c | 2c | C3c | C4c | C5c | C6c |
| Texapon NSO ®, 28% | 32.0% | 32.0% | 32.0% | 32.0% | 32.0% | 32.0% | 32.0% |
| strength, Cognis | | | | | | | |
| (INCI: Sodium Laureth | | | | | | | |
| Sulfate) | | | | | | | |
| TEGO Betain F 50 ®, 38% | 8.0% | 8.0% | 8.0% | 8.0% | 8.0% | 8.0% | 8.0% |
| strength, Evonik | | | | | | | |
| Goldschmidt GmbH | | | | | | | |
| (INCI: Cocamidopropyl | | | | | | | |
| Betaine) | | | | | | | |
| ANTIL 171, Evonik | 2.5% | 2.5% | 2.5% | 2.5% | 2.5% | 2.5% | 2.5% |
| Goldschmidt GmbH | | | | | | | |
| (INCI: PEG-18 Glyceryl | | | | | | | |
| Oleate/Cocoate) | | | | | | | |
| NaCl | 0.5% | 0.5% | 0.5% | 0.5% | 0.5% | 0.5% | 0.5% |
| Polymer JR 400, Amerchol | 0.2% | 0.2% | 0.2% | 0.2% | 0.2% | 0.2% | 0.2% |
| (INCI: Polyquaternium-10) | | | | | | | |
| (cationic polymer to | | | | | | | |
| improve the effectiveness | | | | | | | |
| of conditioning agents) | | | | | | | |
| Water, demineralized | ad 100.0% | | | | | | |
| Example 1 (according to | | 1.0% | | | | | |
| the invention) | | | | | | | |
| Example 2 (according to | | | 1.0% | | | | |
| the invention) | | | | | | | |
| Comparative Example 5 | | | | 1.67% | | | |
| (not according to the | | | | | | | |
| invention, 30% silicone | | | | | | | |
| active content) | | | | | | | |
| Comparative Example 6 | | | | | 0.5% | | |
| (not according to the | | | | | | | |
| invention) | | | | | | | |
| Comparative Example 7 | | | | | | 1.0% | |
| (not according to the | | | | | | | |
| invention, 50% silicone | | | | | | | |
| active content) | | | | | | | |
| Comparative Example 8 | | | | | | | 0.5% |
| (not according to the | | | | | | | |
| invention) | | | | | | | |
| pH | 6 | 6 | 6 | 6 | 6 | 6 | 6 |
| Viscosity [mPas] (after | 6650 | 7730 | 8040 | 6020 | 1280 | 3500 | 2410 |
| 24 hours) | | | | | | | |

By reference to the measurement results in Tab. 5, it is clearly evident that no lowering of the viscosities arises in the case of the aqueous, surface-active formulations 1c and 2c according to the invention compared to the control formulation 0c. Even a slight viscosity increase was observed. By contrast, in the case of the comparison formulations C3c, C4c, C5c and C6c according to the prior art, there is a considerable decrease in the viscosity compared to the control formulation 0c. This viscosity drop is typical when using silicone compounds in aqueous, surface-active formulations and hinders the development of formulations with good conditioning properties to a substantial extent. The observed viscosity drop in the case of the comparison formulation C4c when using PEG-12 Dimethicone is particularly dramatic.
3b) Viscosity Effects in the Case of Shampoo Formulations When Using Guar Quat:

The control formulation 0d used is a formulation without the addition of a silicone compound (conditioner) using 0.2% guar quat. In the case of the formulations 1d and 2d according to the invention and the comparison formulations C3d, C4d, C5d and C6d, 0.2% guar quat with in each case 0.5% silicone compound was used.

The results of the formulations 1d and 2d with the Examples 1 and 2 according to the invention, of the formulations C3d, C4d, C5d and C6d with the comparative Examples 5, 6, 7 and 8 according to the prior art and of the control formulation 0d without the addition of a silicone compound (test formulation) are summarized in Table 6.

TABLE 6
Measured viscosities when using NaCl and PEG-18 Glyceryl Oleate/Cocoate
(ANTIL 171, Evonik Goldschmidt GmbH) for thickening the aqueous, surface-active
formulation.

| | Formulation Examples | | | | | | |
|---|---|---|---|---|---|---|---|
| | 0d | 1d | 2d | C3d | C4d | C5d | C6d |
| Texapon NSO ®, 28% | 32.0% | 32.0% | 32.0% | 32.0% | 32.0% | 32.0% | 32.0% |
| strength, Cognis | | | | | | | |
| (INCI: Sodium Laureth | | | | | | | |
| Sulfate) | | | | | | | |
| TEGO Betain F 50 ®, 38% | 8.0% | 8.0% | 8.0% | 8.0% | 8.0% | 8.0% | 8.0% |
| strength, Evonik | | | | | | | |
| Goldschmidt GmbH | | | | | | | |
| (INCI: Cocamidopropyl | | | | | | | |
| Betaine) | | | | | | | |
| ANTIL 171, Evonik | 2.5% | 2.5% | 2.5% | 2.5% | 2.5% | 2.5% | 2.5% |
| Goldschmidt GmbH | | | | | | | |
| (INCI: PEG-18 Glyceryl | | | | | | | |
| Oleate/Cocoate) | | | | | | | |
| NaCl | 0.5% | 0.5% | 0.5% | 0.5% | 0.5% | 0.5% | 0.5% |
| Jaguar 162, Rhodia | 0.2% | 0.2% | 0.2% | 0.2% | 0.2% | 0.2% | 0.2% |
| (INCI: Guar Hydroxypropyl | | | | | | | |
| trimonium Chloride) | | | | | | | |
| (cationic polymer to | | | | | | | |
| improve the effectiveness | | | | | | | |
| of conditioning agents) | | | | | | | |
| Water, demineralized | ad 100.0% | | | | | | |
| Example 1 (according to | | 1.0% | | | | | |
| the invention) | | | | | | | |
| Example 2 (according to | | | 1.0% | | | | |
| the invention) | | | | | | | |
| Comparative Example 5 | | | | 1.67% | | | |
| (not according to the | | | | | | | |
| invention, 30% silicone | | | | | | | |
| active content) | | | | | | | |
| Comparative Example 6 | | | | | 0.5% | | |
| (not according to the | | | | | | | |
| invention) | | | | | | | |
| Comparative Example 7 | | | | | | 1.0% | |
| (not according to the | | | | | | | |
| invention, 50% silicone | | | | | | | |
| active content) | | | | | | | |
| Comparative Example 8 | | | | | | | 0.5% |
| (not according to the | | | | | | | |
| invention) | | | | | | | |
| pH | 6 | 6 | 6 | 6 | 6 | 6 | 6 |
| Viscosity [mPas] (after | 9013 | 9557 | 10813 | 6020 | 2069 | 4137 | 3744 |
| 24 hours) | | | | | | | |

By reference to the measurement results in Tab. 6, it becomes clearly evident that no reduction in the viscosities takes place in the case of the aqueous, surface-active formulations 1d and 2d according to the invention compared to the control formulation 0d. Even a slight viscosity increase was observed.

By contrast, in the case of the comparison formulations C3d, C4d, C5d and C6d, according to the prior art, there is a considerable decrease in the viscosity compared to the control formulation 0d. This viscosity drop is typical when using silicone compounds in aqueous, surface-active formulations and hinders the development of formulations with good conditioning properties to a substantial extent. The observed viscosity drop in the case of comparison formulation C4d when using PEG-12 Dimethicone is particularly marked.

### FORMULATION EXAMPLES

The following formulation examples show that polysiloxanes according to the invention can be used in a large number of cosmetic formulations.

### Formulation Example 1

### Shampoo

| | |
|---|---|
| TEXAPON ® NSO, Cognis, 28% strength | 32.00% |
| (INCI: Sodium Laureth Sulfate) | |
| Compound Example 1 | 0.50% |
| Perfume | 0.50% |
| Water | 57.50% |
| TEGO ® Betain F 50, Evonik Goldschmidt GmbH, 38% | 8.00% |
| strength (INCI: Cocamidopropyl Betaine) | |
| ANTIL ® 171, Evonik Goldschmidt GmbH | 1.00% |
| (INCI: PEG-18 Glyceryl Oleate/Cocoate) | |
| NaCl | 0.50% |
| Preservative | q.s. |

### Formulation Example 2

### Conditioning Shampoo

| | |
|---|---|
| TEXAPON ® NSO, Cognis, 28% strength | 32.00% |
| (INCI: Sodium Laureth Sulfate) | |
| Compound Example 2 | 1.00% |
| Perfume | 0.50% |
| Water | 55.70% |
| TEGO ® Cosmo C 100, Evonik Goldschmidt GmbH | 1.00% |
| (INCI: Creatine) | |
| Jaguar C-162, Rhodia | 0.30% |
| (INCI: Hydroxypropyl Guar Hydroxypropyltrimonium | |
| Chloride) | |
| TEGO ® Betain F 50, Evonik Goldschmidt GmbH, 38% | 8.00% |
| strength (INCI: Cocamidopropyl Betaine) | |
| NaCl | 1.50% |
| Preservative | q.s. |

### Formulation Example 3

### Conditioning Shampoo

| | |
|---|---|
| TEXAPON ® NSO, Cognis, 28% strength | 32.00% |
| (INCI: Sodium Laureth Sulfate) | |
| ANTIL ® 200, Evonik Goldschmidt GmbH | 2.00% |
| (INCI: PEG-200 Hydrogenated Glyceryl Palmate; PEG-7 | |
| Glyceryl Cocoate) | |
| Compound Example 2 | 1.00% |
| Perfume | 0.25% |
| Water | 57.25% |
| Polymer JR 400, Amerchol | 0.20% |
| (INCI: Polyquaternium-10) | |
| TEGO ® Betain C 60, Evonik Goldschmidt GmbH, 47% | 7.00% |
| strength (INCI: Cocamidopropyl Betaine) | |
| NaCl | 0.30% |
| Preservative | q.s. |

### Formulation Example 4

### Conditioning Shampoo

| | |
|---|---|
| TEXAPON ® NSO, Cognis, 28% strength | 32.00% |
| (INCI: Sodium Laureth Sulfate) | |
| ANTIL ® 200, Evonik Goldschmidt GmbH | 2.00% |
| (INCI: PEG-200 Hydrogenated Glyceryl Palmate; PEG-7 | |
| Glyceryl Cocoate) | |
| ABIL ® Quat 3272, Evonik Goldschmidt GmbH, 50% | 0.75% |
| strength (INCI: Quaternium-80) | |
| Compound Example 3 | 1.00% |
| Perfume | 0.25% |
| Water | 55.50% |
| Polymer JR 400, Amerchol | 0.20% |
| (INCI: Polyquaternium-10) | |
| TEGO ® Betain F 50, Evonik Goldschmidt GmbH, 38% | 8.00% |
| strength (INCI: Cocamidopropyl Betaine) | |
| NaCl | 0.30% |
| Preservative | q.s. |

### Formulation Example 5

### Conditioning Shampoo

| | |
|---|---|
| TEXAPON ® NSO, Cognis, 28% strength | 32.00% |
| (INCI: Sodium Laureth Sulfate) | |
| ANTIL ® 200, Evonik Goldschmidt GmbH | 2.00% |
| (INCI: PEG-200 Hydrogenated Glyceryl Palmate; PEG-7 | |
| Glyceryl Cocoate) | |
| ABIL ® B 8832, Evonik Goldschmidt GmbH | 1.00% |
| (INCI: Bis-PEG/PPG-20/20 Dimethicone) | |
| Compound Example 4 | 0.50% |
| Perfume | 0.25% |
| Water | 55.55% |
| Polymer JR 400, Amerchol | 0.20% |
| (INCI: Polyquaternium-10) | |
| TEGO ® Betain F 50, Evonik Goldschmidt GmbH, 38% | 8.00% |
| strength (INCI: Cocamidopropyl Betaine) | |
| NaCl | 0.30% |
| Preservative | q.s. |

### Formulation Example 6

### Conditioning Shampoo

| | |
|---|---|
| TEXAPON ® NSO, Cognis, 28% strength | 32.00% |
| (INCI: Sodium Laureth Sulfate) | |
| VARISOFT ® PATC, Evonik Goldschmidt GmbH | 1.50% |
| (INCI: Palmitamidopropyltrimonium Chloride) | |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| Compound Example 4 | 0.50% |
| Perfume | 0.25% |
| Water | 54.05% |
| TEGO ® Cosmo C 100, Evonik Goldschmidt GmbH | 1.00% |
| (INCI: Creatine) | |
| Jaguar C-162, Rhodia | 0.20% |
| (INCI: Hydroxypropyl Guar Hydroxypropyltrimonium | |
| Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 7

### Conditioning Shampoo

| | |
|---|---|
| TEXAPON ® NSO, Cognis, 28% strength | 32.00% |
| (INCI: Sodium Laureth Sulfate) | |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| Compound Example 1 | 0.50% |
| Perfume | 0.25% |
| Water | 55.55% |
| TEGO ® Cosmo C 100, Evonik Goldschmidt GmbH | 1.00% |
| (INCI: Creatine) | |
| Jaguar C-162, Rhodia | 0.20% |
| (INCI: Hydroxypropyl Guar Hydroxypropyltrimonium | |
| Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 8

### Pearlized Shampoo

| | |
|---|---|
| TEXAPON ® NSO, Cognis, 28% strength | 32.00% |
| (INCI: Sodium Laureth Sulfate) | |
| Compound Example 2 | 0.50% |
| Perfume | 0.25% |
| Water | 55.25% |
| TEGO ® Betain F 50, Evonik Goldschmidt GmbH, 38% | 8.00% |
| strength (INCI: Cocamidopropyl Betaine) | |
| TEGO ® Pearl N 300, Evonik Goldschmidt GmbH | 2.00% |
| (INCI: Glycol Distearate; Laureth-4; Cocamidopropyl | |
| Betaine) | |
| ANTIL ® 171, Evonik Goldschmidt GmbH | 1.50% |
| (INCI: PEG-18 Glyceryl Oleate/Cocoate) | |
| NaCl | 0.50% |
| Preservative | q.s. |

### Formulation Example 9

### 2 in 1 Shampoo

| | |
|---|---|
| TEXAPON ® NSO, Cognis, 28% strength | 32.00% |
| (INCI: Sodium Laureth Sulfate) | |
| VARISOFT ® PATC, Evonik Goldschmidt GmbH | 1.50% |
| (INCI: Palmitamidopropyltrimonium Chloride) | |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| Compound Example 1 | 0.50% |
| Compound Example 2 | 0.50% |
| Perfume | 0.25% |
| Water | 54.05% |
| TEGO ® Cosmo C 100, Evonik Goldschmidt GmbH | 0.50% |
| (INCI: Creatine) | |
| Jaguar C-162, Rhodia | 0.20% |
| (INCI: Hydroxypropyl Guar Hydroxypropyltrimonium | |
| Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 10

### Rinse-Off Conditioner

| | |
|---|---|
| Water | 90.50% |
| VARISOFT ® BT 85, Evonik Goldschmidt GmbH | 3.00% |
| (INCI: Behentrimonium Chloride) | |
| Compound Example 2 | 1.50% |
| TEGO ® Alkanol 1618, Evonik Goldschmidt GmbH | 5.00% |
| (INCI: Cetearyl Alcohol) | |
| Preservative, Perfume | q.s. |

### Formulation Example 11

### Rinse-Off Conditioner

| | |
|---|---|
| Water | 90.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| Compound Example 1 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 12

### Rinse-Off Conditioner

| | |
|---|---|
| Water | 89.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| ABIL ® Quat 3272, Evonik Goldschmidt GmbH, 50% strength | 1.00% |
| (INCI: Quaternium-80) | |
| Compound Example 1 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 13

### Rinse-Off Conditioner

| | |
|---|---|
| TEGINACID ® C, Evonik Goldschmidt GmbH | 0.50% |
| (INCI: Ceteareth-25) | |
| TEGO ® Alkanol 16, Evonik Goldschmidt GmbH | 2.00% |
| (INCI: Cetyl Alcohol) | |
| TEGO ® Amid S 18, Evonik Goldschmidt GmbH | 1.00% |
| (INCI: Stearamidopropyl Dimethylamine) | |
| Compound Example 2 | 1.50% |
| Propylene Glycol | 2.00% |
| Citric Acid Monohydrate | 0.30% |
| Water | 92.70% |
| Preservative, Perfume | q.s. |

### Formulation Example 14

### Rinse-Off Conditioner

| | |
|---|---|
| TEGINACID ® C, Evonik Goldschmidt GmbH | 0.50% |
| (INCI: Ceteareth-25) | |
| TEGO ® Alkanol 16, Evonik Goldschmidt GmbH | 5.00% |
| (INCI: Cetyl Alcohol) | |
| TEGOSOFT ® DEC, Evonik Goldschmidt GmbH | 1.00% |
| (INCI: Diethylhexyl Carbonate) | |
| Compound Example 1 | 1.50% |
| Water | 89.20% |
| TEGO ® Cosmo C 100, Evonik Goldschmidt GmbH | 0.50% |
| (INCI: Creatine) | |
| Propylene Glycol | 2.00% |
| Citric Acid Monohydrate | 0.30% |
| Preservative, Perfume | q.s. |

### Formulation Example 15

### Leave-In Conditioner Spray

| | |
|---|---|
| Lactic Acid, 80% | 0.40% |
| Water | 95.60% |
| TEGO ® Amid S 18, Evonik Goldschmidt GmbH | 1.20% |
| (INCI: Stearamidopropyl Dimethylamine) | |
| TEGIN ® G 1100 Pellets, Evonik Goldschmidt GmbH | 0.90% |
| (INCI: Glycol Distearate) | |
| TEGO ® Care PS, Evonik Goldschmidt GmbH | 1.20% |
| (INCI: Methyl Glucose Sesquistearate) | |
| TEGOSOFT ® DEC, Evonik Goldschmidt GmbH | 0.30% |
| (INCI: Diethylhexyl Carbonate) | |
| Compound Example 4 | 0.40% |
| Preservative, Perfume | q.s. |

### Formulation Example 16

### Leave-In Conditioner Spray

| | |
|---|---|
| TAGAT ® CH-40, Evonik Goldschmidt GmbH | 2.00% |
| (INCI: PEG-40 Hydrogenated Castor Oil) | |
| Ceramide VI, Evonik Goldschmidt GmbH | 0.05% |
| (INCI: Ceramide 6 II) | |
| Perfume | 0.20% |
| Water | 90.95% |
| Compound Example 1 | 0.50% |
| LACTIL ®, Evonik Goldschmidt GmbH | 2.00% |
| (INCI: Sodium Lactate; Sodium PCA; Glycine; Fructose; Urea; | |
| Niacinamide; Inositol; Sodium Benzoate; Lactic Acid) | |
| TEGO ® Betain F 50, Evonik Goldschmidt GmbH, 38% | 2.30% |
| strength (INCI: Cocamidopropyl Betaine) | |
| Citric Acid (10% in water) | 2.00% |

### Formulation Example 17

### Creamy Shaving Foam

| | |
|---|---|
| Water | 50.00% |
| Coconut Fatty Acid | 1.40% |
| Monoethanolamine | 1.30% |
| Myristic Acid | 3.50% |
| TEGOSOFT ® LSE 65 K Evonik Goldschmidt GmbH | 2.00% |
| (INCI: Sucrose Cocoate) | |
| TEGO ® Betain 810 Evonik Goldschmidt GmbH | 7.60% |
| (INCI: Capryl/Capramidopropyl Betaine) | |
| Glycerin | 5.00% |
| Compound Example 1 | 1.70% |
| Perfume | 0.30% |
| Water | 26.50% |
| TEGOCEL ® HPM 50, Evonik Goldschmidt GmbH | 0.70% |
| (INCI: Hydroxypropyl Methylcellulose) | |

### Formulation Example 18

### Body Wash

| | |
|---|---|
| TEXAPON ® NSO, Cognis, 28% strength | 30.00% |
| (INCI: Sodium Laureth Sulfate) | |
| TEGOSOFT ® PC 31, Evonik Goldschmidt GmbH | 0.50% |
| (INCI: Polyglyceryl-3 Caprate) | |
| Compound Example 1 | 0.30% |
| Perfume | 0.30% |
| Water | 54.10% |
| TEGOCEL ® HPM 4000, Evonik Goldschmidt GmbH | 0.30% |
| (INCI: Hydroxypropyl Methylcellulose) | |
| REWOTERIC ® AM C, Evonik Goldschmidt GmbH, 32% | 10.00% |
| strength (INCI: Sodium Cocoamphoacetate) | |
| Citric Acid Monohydrate | 0.50% |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| TEGO ® Pearl N 300, Evonik Goldschmidt GmbH | 2.00% |
| (INCI: Glycol Distearate; Laureth-4; Cocamidopropyl | |
| Betaine) | |

### Formulation Example 19

### Mild Shower Bath

| | |
|---|---|
| TEXAPON ® NSO, Cognis, 28% strength | 27.00% |
| (INCI: Sodium Laureth Sulfate) | |
| REWOPOL ® SB FA 30, Evonik Goldschmidt GmbH, 40% | 12.00% |
| strength (INCI: Disodium Laureth Sulfosuccinate) | |
| TEGOSOFT ® LSE 65 K SOFT, Evonik Goldschmidt GmbH | 2.00% |
| (INCI: Sucrose Cocoate) | |
| Water | 39.00% |
| REWOTERIC ® AM C, Evonik Goldschmidt GmbH, 32% | 13.00% |
| strength (INCI: Sodium Cocoamphoacetate) | |
| Compound Example 2 | 0.50% |
| Citric Acid (30% in water) | 3.00% |
| ANTIL ® 171, Evonik Goldschmidt GmbH | 1.50% |
| (INCI: PEG-18 Glyceryl Oleate/Cocoate) | |
| TEGO ® Pearl N 300, Evonik Goldschmidt GmbH | 2.00% |
| (INCI: Glycol Distearate; Laureth-4; Cocamidopropyl | |
| Betaine) | |

### Formulation Example 20

### Leave-In Conditioner Foam

| | |
|---|---|
| Compound Example 1 | 0.50% |
| TAGAT ® CH 40, Evonik Goldschmidt GmbH | 0.50% |
| (INCI: PEG-40 Hydrogenated Castor Oil) | |
| Perfume | 0.30% |
| TEGO ® Betain 810, Evonik Goldschmidt GmbH | 2.00% |
| (INCI: Capryl/Capramidopropyl Betaine) | |
| Water | 94.00% |
| TEGO ® Cosmo C 100, Evonik Goldschmidt GmbH | 0.50% |
| (INCI: Creatine) | |
| TEGOCEL ® HPM 50, Evonik Goldschmidt GmbH | 0.30% |
| (INCI: Hydroxypropyl Methylcellulose) | |
| VARISOFT ® 300, Evonik Goldschmidt GmbH | 1.30% |
| (INCI: Cetrimonium Chloride) | |
| LACTIL ® Evonik Goldschmidt GmbH | 0.50% |
| (INCI: Sodium Lactate; Sodium PCA; Glycine; Fructose; Urea; | |
| Niacinamide; Inositol; Sodium Benzoate; Lactic Acid) | |
| Citric Acid (30% in water) | 0.10% |
| Preservative | q.s. |

### Formulation Example 21

### Strong Hold Styling Gel

| | |
|---|---|
| TEGO ® Carbomer 141, Evonik Goldschmidt GmbH | 1.20% |
| (INCI: Carbomer) | |
| Water | 67.00% |
| NaOH, 25% | 2.70% |
| PVP/VA W-735, ISP | 16.00% |
| (INCI: PVP/VA Copolymer) | |
| Compound Example 1 | 0.50% |
| Alcohol Denat. | 10.00% |
| TAGAT ® O 2 V, Evonik Goldschmidt GmbH | 2.00% |
| (INCI: PEG-20 Glyceryl Oleate) | |
| Perfume | 0.30% |
| ABIL ® B 88183, Evonik Goldschmidt GmbH | 0.30% |
| (INCI: PEG/PPG-20/6 Dimethicone) | |
| Preservative | q.s. |

### Formulation Example 22

### Foamy Body Care Composition

| | |
|---|---|
| TEXAPON ® NSO, Cognis, 28% strength | 14.30% |
| (INCI: Sodium Laureth Sulfate) | |
| Perfume | 0.30% |
| Compound Example 4 | 0.50% |
| REWOTERIC ® AM C, Evonik Goldschmidt GmbH, 32% | 8.00% |
| strength (INCI: Sodium Cocoamphoacetate) | |
| Water | 74.90% |
| TEGOCEL ® HPM 50, Evonik Goldschmidt GmbH | 0.50% |
| (INCI: Hydroxypropyl Methylcellulose) | |
| LACTIL ®, Evonik Goldschmidt GmbH | 1.00% |
| (INCI: Sodium Lactate; Sodium PCA; Glycine; Fructose; | |
| Urea; Niacinamide; Inositol; Sodium Benzoate; Lactic | |
| Acid) | |
| Citric Acid Monohydrate | 0.50% |

### Formulation Example 23

### Body Care Composition

| | |
|---|---|
| TEXAPON ® NSO, Cognis, 28% strength | 30.00% |
| (INCI: Sodium Laureth Sulfate) | |
| TEGOSOFT ® PC 31, Evonik Goldschmidt GmbH | 0.50% |
| (INCI: Polyglyceryl-3 Caprate) | |
| Compound Example 4 | 0.50% |
| Perfume | 0.30% |
| Water | 53.90% |
| TEGOCEL ® HPM 4000, Evonik Goldschmidt GmbH | 0.30% |
| (INCI: Hydroxypropyl Methylcellulose) | |
| REWOTERIC ® AM C, Evonik Goldschmidt GmbH, 32% | 10.00% |
| strength (INCI: Sodium Cocoamphoacetate) | |
| Citric Acid Monohydrate | 0.50% |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| TEGO ® Pearl N 300, Evonik Goldschmidt GmbH | 2.00% |
| (INCI: Glycol Distearate; Laureth-4; Cocamidopropyl | |
| Betaine) | |

### Formulation Example 24

### Foamy Body Care Composition

| | |
|---|---|
| TEXAPON ® NSO, Cognis, 28% strength | 14.30% |
| (INCI: Sodium Laureth Sulfate) | |
| Perfume | 0.30% |
| Compound Example 3 | 1.00% |
| REWOTERIC ® AM C, Evonik Goldschmidt GmbH, 32% | 8.00% |
| strength (INCI: Sodium Cocoamphoacetate) | |
| Water | 74.60% |
| Polyquaternium-7 | 0.30% |
| LACTIL ®, Evonik Goldschmidt GmbH | 1.00% |
| (INCI: Sodium Lactate; Sodium PCA; Glycine; Fructose; | |
| Urea; Niacinamide; Inositol; Sodium Benzoate; Lactic | |
| Acid) | |
| Citric Acid Monohydrate | 0.50% |

### Formulation Example 25

### Mild Foam Bath

| | |
|---|---|
| TEXAPON ® NSO, Cognis, 28% strength | 27.00% |
| (INCI: Sodium Laureth Sulfate) | |
| REWOPOL ® SB FA 30, Evonik Goldschmidt GmbH, 40% | 12.00% |
| strength (INCI: Disodium Laureth Sulfosuccinate) | |
| TEGOSOFT ® LSE 65 K SOFT, Evonik Goldschmidt | 2.00% |
| GmbH (INCI: Sucrose Cocoate) | |
| Water | 39.00% |
| REWOTERIC ® AM C, Evonik Goldschmidt GmbH, 32% | 13.00% |
| strength (INCI: Sodium Cocoamphoacetate) | |
| Compound Example 2 | 0.50% |
| Citric Acid (30% in water) | 3.00% |
| ANTIL ® 171, Evonik Goldschmidt GmbH | 1.50% |
| (INCI: PEG-18 Glyceryl Oleate/Cocoate) | |
| TEGO ® Pearl N 300, Evonik Goldschmidt GmbH | 2.00% |
| (INCI: Glycol Distearate; Laureth-4; Cocamidopropyl | |
| Betaine) | |

### Formulation Example 26

### Foamy Body Care Composition

| | |
|---|---|
| TEGOCEL ® HPM 50, Evonik Goldschmidt GmbH | 0.50% |
| (INCI: Hydroxypropyl Methylcellulose) | |
| Water | 80.10% |
| Perfume | 0.20% |
| Compound Example 1 | 0.50% |
| TEGOSOFT ® GC, Evonik Goldschmidt GmbH | 1.30% |
| (INCI: PEG-7 Glyceryl Cocoate) | |
| TEGO ® Betain 810, Evonik Goldschmidt GmbH | 16.90% |
| (INCI: Capryl/Capramidopropyl Betaine) | |
| LACTIL ®, Evonik Goldschmidt GmbH | 0.50% |
| (INCI: Sodium Lactate; Sodium PCA; Glycine; Fructose; Urea; | |
| Niacinamide; Inositol; Sodium Benzoate; Lactic Acid) | |
| Preservative | q.s. |

### Formulation Example 27

### Rinse-Off Conditioner

| | |
|---|---|
| Water | 89.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| ABIL ® OSW 5, Evonik Goldschmidt GmbH | 1.00% |
| (INCI: Cyclopentasiloxane; Dimethiconol) | |
| Compound Example 1 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 28

### Rinse-Off Conditioner

| | |
|---|---|
| Water | 89.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| ABIL ® Soft AF 100, Evonik Goldschmidt GmbH | 1.00% |
| (INCI: Methoxy PEG/PPG-7/3 Aminopropyl Dimethicone) | |
| Compound Example 1 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 29

### Rinse-Off Conditioner

| | |
|---|---|
| Water | 89.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| SF 1708, Momentive | 1.00% |
| (INCI: Amodimethicone) | |
| Compound Example 1 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 30

### Conditioning Shampoo

| | |
|---|---|
| TEXAPON ® NSO, Cognis, 28% strength | 27.00% |
| (INCI: Sodium Laureth Sulfate) | |
| Plantacare 818 UP, Cognis, 51.4% strength | 5.00% |
| (INCI: Coco Glucoside) | |
| Compound Example 2 | 1.50% |
| Perfume | 0.25% |
| Water | 56.55% |
| TEGO ® Cosmo C 100, Evonik Goldschmidt GmbH | 1.00% |
| (INCI: Creatine) | |
| Jaguar C-162, Rhodia | 0.20% |
| (INCI: Hydroxypropyl Guar Hydroxypropyltrimonium Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 31

### Conditioning Shampoo

| | |
|---|---|
| Plantacare 818 UP, Cognis, 51.4% strength | 18.00% |
| (INCI: Coco Glucoside) | |
| Compound Example 2 | 1.50% |
| Perfume | 0.25% |
| Water | 70.55% |
| TEGO ® Cosmo C 100, Evonik Goldschmidt GmbH | 1.00% |
| (INCI: Creatine) | |
| Jaguar C-162, Rhodia | 0.20% |
| (INCI: Hydroxypropyl Guar Hydroxypropyltrimonium Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 32

### Pearlized Shampoo

| | |
|---|---|
| TEXAPON ® NSO, Cognis, 28% strength | 32.00% |
| (INCI: Sodium Laureth Sulfate) | |
| Compound Example 1 | 0.75% |
| Perfume | 0.25% |
| Water | 56.00% |
| TEGO ® Betain F 50, Evonik Goldschmidt GmbH, 38% | 8.00% |
| strength (INCI: Cocamidopropyl Betaine) | |
| TEGIN ® D 1102, Evonik Goldschmidt GmbH | 1.00% |
| (INCI: PEG-3 Distearate) | |
| ANTIL ® 171, Evonik Goldschmidt GmbH | 1.50% |
| (INCI: PEG-18 Glyceryl Oleate/Cocoate) | |
| NaCl | 0.50% |
| Preservative | q.s. |

### Formulation Example 33

### “Two in One” Shampoo

| | | |
|---|---|---|
| A | TEXAPON ® NSO, Cognis, 28% strength, (INCI: Sodium | 30.00% |
| | Laureth Sulfate) | |
| | Perfume | 0.50% |
| | Stepanate ® SCS, Stepan, (INCI: Sodium Cumene- | 1.00% |
| | sulfonate) | |
| | Water | 16.25% |
| | TEGO ® Betain F 50, Evonik Goldschmidt GmbH, 38% | 8.00% |
| | strength, (INCI: Cocamidopropyl Betaine) | |
| B | TEXAPON ® NSO, Cognis, 28% strength, (INCI: Sodium | 15.00% |
| | Laureth Sulfate) | |
| | Stepanate ® SCS, Stepan, (INCI: Sodium Cumene- | 1.00% |
| | sulfonate) | |
| | Water | 5.00% |
| | REWOMID ® C 212, Evonik Goldschmidt GmbH, (INCI: | 1.50% |
| | Cocamide MEA) | |
| | TEGIN ® G 1100 Pellets, Evonik Goldschmidt GmbH, | 1.50% |
| | (INCI: Glycol Distearate) | |
| C | TEXAPON ® NSO, Cognis, 28% strength, (INCI: Sodium | 15.00% |
| | Laureth Sulfate) | |
| | TEGO ® Alkanol 16, Evonik Goldschmidt GmbH, (INCI: | 0.50% |
| | Cetyl Alcohol) | |
| | Compound Example 2 | 1.50% |
| | Dimethicone (10000 mPa · s) | 1.50% |
| | Stepanate ® SCS, Stepan, (INCI: Sodium Cumene- | 1.00% |
| | sulfonate) | |
| | Keltrol ®, CP Telco, (INCI: Xanthan Gum) | 0.75% |
| | Preservative | q.s. |

### Formulation Example 34

### Conditioning Anti-Dandruff Shampoo

| | | |
|---|---|---|
| A | TEGIN ® G 1100 Pellets, Evonik Goldschmidt GmbH, | 3.00% |
| | (INCI: Glycol Distearate) | |
| | TEXAPON ® NSO, Cognis, 28% strength, (INCI: Sodium | 40.00% |
| | Laureth Sulfate) | |
| B | Perfume | 0.30% |
| | Zinc-Pyrion NF, WeylChem, 48% strength, (INCI: Zinc | 2.00% |
| | Pyrithione) | |
| | Compound Example 2 | 2.00% |
| C | Water | 35.70% |
| | TEGO ® Carbomer 341 ER, Evonik Goldschmidt GmbH, | 0.20% |
| | (INCI: Acrylates/C10-30 Alkyl Acrylate Crosspolymer) | |
| | Water | 0.30% |
| | NaOH, 25% strength | 0.30% |
| D | REWOTERIC ® AM B U 185, Evonik Goldschmidt | 12.50% |
| | GmbH, 30% strength, (INCI: Undecylenamidopropyl | |
| | Betaine) | |
| | ANTIL ® SPA 80, Evonik Goldschmidt GmbH, | 3.70% |
| | (INCI: Isostearamide MIPA; Glyceryl Laurate) | |
| E | Preservative | q.s. |

### Formulation Example 35

### Hair Colourant 1

| | |
|---|---|
| Water demineralized | 57.40% |
| TEGO ® Alkanol 1618, Evonik Goldschmidt GmbH, | 12.00% |
| (INCI: Cetearyl Alcohol) | |
| Eutanol ® G, BASF Cognis, (INCI: Octyldodecanol) | 3.00% |
| REWOMID ® C 212, Evonik Goldschmidt GmbH, | 1.50% |
| (INCI: Cocamide MEA) | |
| Super Hartolan ® B, Croda, (INCI: Lanolin Alcohol) | 3.00% |
| Avocado oil, Henry Lamotte, (INCI: Persea Gratissima Oil) | 1.50% |
| Pristerene ® 4960, Uniquema, (INCI: Stearic Acid) | 6.00% |
| EDTA BD, BASF, (INCI: Disodium EDTA) | 0.10% |
| Texapon ® K12G, BASF Cognis, (INCI: Sodium Lauryl | 0.50% |
| Sulfate) | |
| Propylene glycol | 5.00% |
| Timica Silver Sparkle, BASF, (INCI: MICA; Titanium Dioxide) | 1.00% |
| Ammonia solution, 25% strength | 6.00% |
| 2,5-Diaminotoluene sulphate, (INCI: Toluene-2,5-Diamine) | 1.40% |
| Rodol ® RS, Jos. H. Lowenstein & Sons, (INCI: Resorcinol) | 0.30% |
| HC Blue A42, (INCI: 2,4-Diaminophenoxyethanol di HCl) | 0.10% |
| Sodium sulphite | 0.50% |
| Perfume | 0.20% |
| Compound Example 1 (according to the invention) | 0.50% |

### Formulation Example 36

### Hair Colourant 2

| | |
|---|---|
| Water demineralized | 64.00% |
| TEGO ® Alkanol 1618, Evonik Goldschmidt GmbH, | 12.00% |
| (INCI: Cetearyl Alcohol) | |
| Super Hartolan ® B, Croda, (INCI: Lanolin Alcohol) | 2.50% |
| Meadowfoam ® Seed Oil, Fanning, (INCI: Limnanthes Alba) | 1.00% |
| Pristerene ® 4960, Uniquema, (INCI: Stearic Acid) | 5.50% |
| EDTA BD, BASF, (INCI: Disodium EDTA) | 0.10% |
| Glycerin | 5.00% |
| Texapon ® N 70, BASF Cognis, (INCI: Sodium Laureth | 2.00% |
| Sulfate) | |
| Monoethanolamine | 4.00% |
| 2,5-Diaminotoluene sulphate, (INCI: Toluene-2,5-Diamine) | 0.90% |
| Rodol ® RS, Jos. H. Lowenstein & Sons, (INCI: Resorcinol) | 0.20% |
| Jarocol ® 4A3MP, Vivimed Labs, (INCI: 4-Amino-M-Cresol) | 0.60% |
| Rodol ® PAOC, Jos. H. Lowenstein & Sons, | 0.50% |
| (INCI: 4-Amino-2-Hydroxytoluene) | |
| Uantox ® EBATE, Universal Preserv-A-Chem, | 0.50% |
| (INCI: Erythorbic Acid) | |
| Perfume | 0.20% |
| Compound Example 2 (according to the invention) | 1.00% |

### Formulation Example 37

### Hair Colourant 3

| | |
|---|---|
| Water demineralized | 67.50% |
| TEGO ® Alkanol 1618, Evonik Goldschmidt GmbH, | 10.00% |
| (INCI: Cetearyl Alcohol) | |
| Eutanol ® G, BASF Cognis, (INCI: Octyldodecanol) | 1.00% |
| REWOMID ® C 212, Evonik Goldschmidt GmbH, | 2.00% |
| (INCI: Cocamide MEA) | |
| TEGIN ® VS, Evonik Goldschmidt GmbH, | 5.00% |
| (INCI: Glyceryl Stearate SE) | |
| Fitoderm ®, Hispano Quimica S.A., (INCI: Squalane) | 1.00% |
| Coenzyme Q 10 | 0.10% |
| EDTA BD, BASF, (INCI: Disodium EDTA) | 0.10% |
| Texapon ® K12G, BASF Cognis, (INCI: Sodium Lauryl | 0.10% |
| Sulfate) | |
| Propylene glycol | 5.00% |
| Ammonia solution, 25% strength | 3.00% |
| Rodol ® ERN, Jos. H. Lowenstein & Sons, (INCI: 1-Naphthol) | 0.30% |
| Imexine ® OAG, Chimex, | 1.00% |
| (INCI: 2-Methyl-5-Hydroxyethylaminophenol) | |
| Colorex ® WP5, Teluca, | 2.60% |
| (INCI: 1-Hydroxyethyl 4,5-Diamino Pyrazole Sulfate) | |
| Ascorbic acid | 0.30% |
| Perfume | 0.30% |
| Compound Example 1 (according to the invention) | 0.70% |

### Formulation Example 38

### Hair Colourant 4

| | |
|---|---|
| Water demineralized | 60.70% |
| TEGO ® Alkanol 1618, Evonik Goldschmidt GmbH, | 13.00% |
| (INCI: Cetearyl Alcohol) | |
| REWOMID ® C 212, Evonik Goldschmidt GmbH, | 2.00% |
| (INCI: Cocamide MEA) | |
| Super Hartolan ® B, Croda, (INCI: Lanolin Alcohol) | 2.50% |
| Avocado oil, Henry Lamotte, (INCI: Persea Gratissima Oil) | 2.00% |
| Pristerene ® 4960, Uniquema, (INCI: Stearic Acid) | 6.00% |
| EDTA BD, BASF, (INCI: Disodium EDTA) | 0.10% |
| Texapon ® K12G, BASF Cognis, (INCI: Sodium Lauryl | 0.10% |
| Sulfate) | |
| Propylene glycol | 5.00% |
| Ammonia solution, 25% strength | 6.00% |
| 2,5-Diaminotoluene sulphate, (INCI: Toluene-2,5-Diamine) | 1.30% |
| Rodol ® RS, Jos. H. Lowenstein & Sons, (INCI: Resorcinol) | 0.30% |
| Covastyle ® TBQ, LCW Les colourants Wackherr S.A., | 0.30% |
| (t-Butyl Hydroquinone) | |
| Perfume | 0.20% |
| Compound Example 2 (according to the invention) | 0.50% |

### Formulation Example 39

### 2 in 1 Shampoo 2

| | |
|---|---|
| TEXAPON ® NSO, Cognis, 28% strength | 32.00% |
| (INCI: Sodium Laureth Sulfate) | |
| VARISOFT ® PATC, Evonik Goldschmidt GmbH | 1.50% |
| (INCI: Palmitamidopropyltrimonium Chloride) | |
| REWODERM ® LI S 80, Evonik Goldschmidt GmbH | 2.00% |
| (INCI: PEG-200 Hydrogenated Glyceryl Palmate; PEG-7 | |
| Glyceryl Cocoate) | |
| Compound Example 9 | 0.50% |
| Compound Example 10 | 0.50% |
| Perfume | 0.25% |
| Water | 54.05% |
| TEGO ® Cosmo C 100, Evonik Goldschmidt GmbH | 0.50% |
| (INCI: Creatine) | |
| Jaguar C-162, Rhodia | 0.20% |
| (INCI: Hydroxypropyl Guar Hydroxypropyltrimonium Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 40

### Rinse-Off Conditioner 2

| | |
|---|---|
| Water | 90.20% |
| VARISOFT ® EQ 65, Evonik Goldschmidt GmbH | 2.00% |
| (INCI: Distearyl Dimonium Chloride; Cetearyl Alcohol) | |
| VARISOFT ® BT 85, Evonik Goldschmidt GmbH | 2.00% |
| (INCI: Behentrimonium Chloride) | |
| Compound Example 11 | 0.80% |
| TEGO ® Alkanol 1618, Evonik Goldschmidt GmbH | 5.00% |
| (INCI: Cetearyl Alcohol) | |
| Preservative, Perfume | q.s. |

### Formulation Example 41

### Leave-In Conditioner Spray 2

| | |
|---|---|
| TAGAT ® CH-40, Evonik Goldschmidt GmbH | 2.00% |
| (INCI: PEG-40 Hydrogenated Castor Oil) | |
| Ceramide VI, Evonik Goldschmidt GmbH | 0.05% |
| (INCI: Ceramide 6 II) | |
| Perfume | 0.20% |
| Water | 90.95% |
| Compound Example 9 | 0.50% |
| LACTIL ®, Evonik Goldschmidt GmbH | 2.00% |
| (INCI: Sodium Lactate; Sodium PCA; Glycine; Fructose; | |
| Urea; Niacinamide; Inositol; Sodium Benzoate; Lactic | |
| Acid) | |
| TEGO ® Betain F 50, Evonik Goldschmidt GmbH, 38% | 2.30% |
| strength (INCI: Cocamidopropyl Betaine) | |
| Citric Acid (10% in water) | 2.00% |

### Formulation Example 42

### Foamy Body Care Composition 2

| | |
|---|---|
| TEXAPON ® NSO, Cognis, 28% strength | 14.30% |
| (INCI: Sodium Laureth Sulfate) | |
| Perfume | 0.30% |
| Compound Example 10 | 1.00% |
| REWOTERIC ® AM C, Evonik Goldschmidt GmbH, 32% | 8.00% |
| strength (INCI: Sodium Cocoamphoacetate) | |
| Water | 74.60% |
| Polyquaternium-7 | 0.30% |
| LACTIL ®, Evonik Goldschmidt GmbH | 1.00% |
| (INCI: Sodium Lactate; Sodium PCA; Glycine; Fructose; | |
| Urea; Niacinamide; Inositol; Sodium Benzoate; Lactic | |
| Acid) | |
| Citric Acid Monohydrate | 0.50% |

### Formulation Example 43

### Conditioning Shampoo 2

| | |
|---|---|
| TEXAPON ® NSO, Cognis, 28% strength | 27.00% |
| (INCI: Sodium Laureth Sulfate) | |
| Plantacare 818 UP, Cognis, 51.4% strength | 5.00% |
| (INCI: Coco Glucoside) | |
| Compound Example 11 | 1.50% |
| Perfume | 0.25% |
| Water | 56.55% |
| TEGO ® Cosmo C 100, Evonik Goldschmidt GmbH | 1.00% |
| (INCI: Creatine) | |
| Jaguar C-162, Rhodia | 0.20% |
| (INCI: Hydroxypropyl Guar Hydroxypropyltrimonium | |
| Chloride) | |
| TEGO ® Betain F 50, Evonik Goldschmidt GmbH, 38% | 8.00% |
| strength (INCI: Cocamidopropyl Betaine) | |
| NaCl | 0.50% |
| Preservative | q.s. |

### Formulation Example 44

### Conditioning Anti-Dandruff Shampoo 2

| | | |
|---|---|---|
| A | TEGIN ® G 1100 Pellets, Evonik Goldschmidt GmbH, | 3.00% |
| | (INCI: Glycol Distearate) | |
| | TEXAPON ® NSO, Cognis, 28% strength, (INCI: Sodium | 40.00% |
| | Laureth Sulfate) | |
| B | Perfume | 0.30% |
| | Zinc-Pyrion NF, WeylChem, 48% strength, (INCI: Zinc | 2.00% |
| | Pyrithione) | |
| | Compound Example 9 | 2.00% |
| C | Water | 35.70% |
| | TEGO ® Carbomer 341 ER, Evonik Goldschmidt GmbH, | 0.20% |
| | (INCI: Acrylates/C10-30 Alkyl Acrylate Crosspolymer) | |
| | Water | 0.30% |
| | NaOH, 25% strength | 0.30% |
| D | REWOTERIC ® AM B U 185, Evonik Goldschmidt | 12.50% |
| | GmbH, 30% strength, (INCI: Undecylenamidopropyl | |
| | Betaine) | |
| | ANTIL ® SPA 80, Evonik Goldschmidt GmbH, | 3.70% |
| | (INCI: Isostearamide MIPA; Glyceryl Laurate) | |
| E | Preservative | q.s. |

### Formulation Example 45

### Hair Colourant 5

| | |
|---|---|
| Water demineralized | 57.40% |
| TEGO ® Alkanol 1618, Evonik Goldschmidt GmbH, | 12.00% |
| (INCI: Cetearyl Alcohol) | |
| Eutanol ® G, BASF Cognis, (INCI: Octyldodecanol) | 3.00% |
| REWOMID ® C 212, Evonik Goldschmidt GmbH, | 1.50% |
| (INCI: Cocamide MEA) | |
| Super Hartolan ® B, Croda, (INCI: Lanolin Alcohol) | 3.00% |
| Avocado oil, Henry Lamotte, (INCI: Persea Gratissima Oil) | 1.50% |
| Pristerene ® 4960, Uniquema, (INCI: Stearic Acid) | 6.00% |
| EDTA BD, BASF, (INCI: Disodium EDTA) | 0.10% |
| Texapon ® K12G, BASF Cognis, (INCI: Sodium Lauryl | 0.50% |
| Sulfate) | |
| Propylene glycol | 5.00% |
| Timica Silver Sparkle, BASF, (INCI: MICA; Titanium Dioxide) | 1.00% |
| Ammonia solution, 25% strength | 6.00% |
| 2,5-Diaminotoluene sulphate, (INCI: Toluene-2,5-Diamine) | 1.40% |
| Rodol ® RS, Jos. H. Lowenstein & Sons, (INCI: Resorcinol) | 0.30% |
| HC Blue A42, (INCI: 2,4-Diaminophenoxyethanol di HCl) | 0.10% |
| Sodium sulphite | 0.50% |
| Perfume | 0.20% |
| Compound Example 11 | 0.50% |

1. A process for the preparation of polysiloxanes containing at least one betaine group, comprising:
adding organopolysiloxanes of formula I 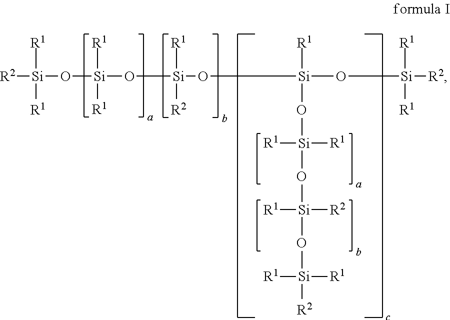
in which
R¹ independently of the others, is identical or different, branched or unbranched, aliphatic or aromatic hydrocarbon radicals having 1 to 20 carbon atoms,
R² independently of the others, is identical or different radicals R¹ or H, with the proviso that at least three radicals R² are H,
a is 5 to 500, preferably 10 to 250, in particular 15 to 75,
b is 1 to 50, preferably 1 to 20, in particular 3 to 15,
c is 0 to 10, preferably 0 to 5, in particular 0, to vinylsiloxanes of the-general formula II,
where 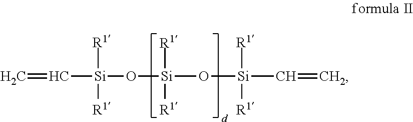
where
R^{1′} independently of the others, is identical or different, branched or unbranched, aliphatic or aromatic hydrocarbon radicals having 1 to 20 carbon atoms,
d is 10 to 1000,
in the presence of platinum or rhodium catalysts,
with the proviso that the organopolysiloxanes of formula I are present in an at least 6-fold and at most 40-fold molar excess, based on the vinylsiloxane of formula II,
to give a reaction product having SiH groups;
reacting said reaction product having Si—H groups by transition-metal-catalysed, partial or complete addition of the SiH groups onto at least one compound having at least one epoxy group selected from alkenyl and alkynyl compounds to provide epoxy silanes; and
reacting, partially or completely, the epoxy siloxanes by performing d1) and/or d2):
d1) with at least one amino acid derivative of formula IV 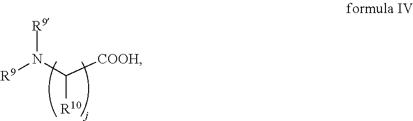
where
R⁹ is alkyl radical having 1 to 6 carbon atoms,
R^{9′} is alkyl radical having 1 to 6 carbon atoms,
R^{9′} is alkyl radical having 1 to 6 carbon atoms,
R¹⁰ independently of the others, is identical or different, branched or unbranched, aliphatic or aromatic hydrocarbon radicals having 1 to 20 carbon atoms,
j is 1 to 10, to give betaine-group-modified siloxanes;
d2) with at least one secondary or tertiary amino compound selected from the group of formulae V, VI and VII, 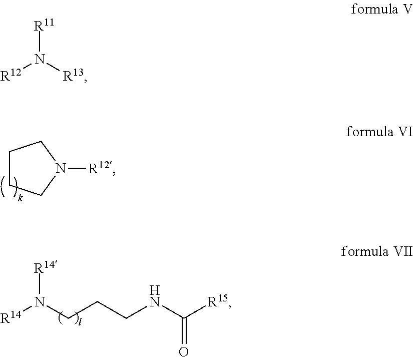
where
R¹¹ is alkyl radicals having 1 to 6 carbon atoms,
R¹² is hydrogen or alkyl having 1 to 6 carbon atoms,
R¹³ is alkyl, aryl or alkaryl radical having 1 to 30 carbon atoms
R^{12′} is hydrogen or alkyl having 1 to 6 carbon atoms,
k is 0 to 4,
R¹⁴ is ethyl or methyl,
R^{14′} is ethyl or methyl,
R¹⁵ is optionally branched, saturated or unsaturated alkyl radical having 1 to 30 carbon atoms,
l is 0 to 4,
with the proviso that in the case of formula VII or in the case of tertiary amines of formula V or VI, an acid H⁺X⁻ is added in equimolar amounts with respect to this tertiary amine,
where
X⁻ is identical or different counterions to the positive charges on the quaternary ammonium groups formed, selected from inorganic or organic anions of the acids HX,
to give tertiary amino- or quaternary ammonium-group-modified siloxanes.

2. The process according to claim 1, wherein at least one solvent, is used.

3. The process according to claim 1, wherein at least one precious metal catalyst is used in at least one of said adding step and said reacting said product having Si—H groups.

4. (canceled)

5. A polysiloxane containing at least one betaine group and obtained by a process according to claim 1.

6. (canceled)

7. (canceled)

8. (canceled)

9. A formulation comprising at least one polysiloxane obtained by the process of claim 1.

10. (canceled)

11. The process of claim 1, further comprising:
additional, transition-metal-catalysed, partial or complete addition of remaining SiH groups of the reaction product having SiH groups onto at least one compound selected from alkenyl and alkynyl compounds.

12. The process of claim 11, wherein said at least one compound is selected from the group consisting of α-olefins or polyethers containing double bonds.

13. The process of claim 12, wherein the a-olefins or polyethers containing double bonds are selected from the group consisting of 1-dodecene, 1-hexadecene, 1-octadecene and allyl polyethers of formula III 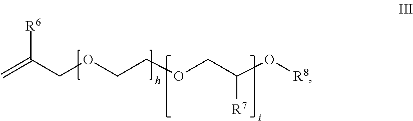
where
R⁶ is hydrogen or alkyl having 1 to 6 carbon atoms,
R⁷ independently of the others, is identical or different alkyl, aryl or alkaryl radicals having 1 to 30 carbon atoms,
R⁸ is alkyl radical having 1 to 18 carbon atoms, an acetate radical or hydrogen,
h is 0 to 100,
is 0 to 100.

14. The process of claim 1, further comprising:
reacting the resulting tertiary amino groups with
[Y(CH₂)ₘCOO]_{1/n}Z formula VIII,
where
Y⁻ is ethyl sulphate, methyl sulphate, toluenesulphonate, bromide or chloride,
Zⁿ⁺ is alkali metal or alkaline earth metal cations, and
m is 1 to 6,
to give betaine groups.

15. The process of claim 11, wherein at least one precious metal catalyst is used.

16. The process according to claim 11, wherein said at least one compound is selected from the group consisting of polyethers with multiple bonds, allyl-functional polyethers, olefins, ethene, ethyne, propene, 1-butene, 1-hexene, 1-dodecene, 1-hexadecene, allyl alcohol, 1-hexenol, styrene, eugenol, allylphenol and undecylenic acid methyl ester.

17. The process according to claim 11, wherein said at least one compound comprises allyl-functional polyethers.

18. The process of claim 11, wherein said at least one compound comprises alkenyl compounds selected from the group consisting of: 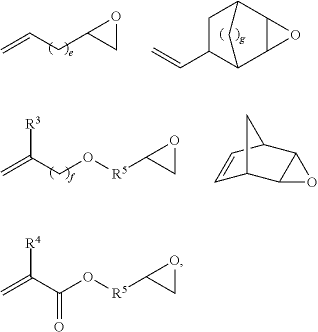
where
R³ is hydrogen or alkyl having 1 to 6 carbon atoms,
R⁴ is hydrogen or alkyl having 1 to 6 carbon atoms,
R⁵ independently of the others, is identical or different divalent hydrocarbon radicals which optionally contain ether functions,
e is 0 to 30,
f is 0 to 18,
g is 0 to 2.

19. The process according to claim 1, wherein the least one epoxy group is selected from the group consisting of 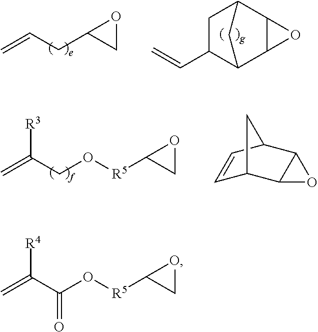
where
R³ is hydrogen or alkyl having 1 to 6 carbon atoms,
R⁴ is hydrogen or alkyl having 1 to 6 carbon atoms,
R⁵ independently of the others, is identical or different divalent hydrocarbon radicals which optionally contain ether functions,
e is 0 to 30,
f is 0 to 18,
g is 0 to 2.
